(19) United States
(12) Patent Application Publication
(10) Pub. No.: US 2024/0177005 A1
(43) Pub. Date: May 30, 2024

(54) APPARATUS AND METHOD FOR EVALUATING CORRECTNESS OF AI/ML MODEL

(71) Applicant: ELECTRONICS AND TELECOMMUNICATIONS RESEARCH INSTITUTE, Daejeon (KR)

(72) Inventors: Joo Young LEE, Daejeon (KR); Tae Yeon KIM, Daejeon (KR)

(73) Assignee: ELECTRONICS AND TELECOMMUNICATIONS RESEARCH INSTITUTE, Daejeon (KR)

(21) Appl. No.: 18/521,391

(22) Filed: Nov. 28, 2023

(30) Foreign Application Priority Data
Nov. 30, 2022 (KR) 10-2022-0164924

(51) Int. Cl. G06N 3/08

(52) U.S. Cl. CPC G06N 3/08

(57) ABSTRACT

A method for verifying reliability of an artificial intelligence (AI) model includes receiving an AI model request; creating a verification twin for evaluating the reliability of the AI model; and verifying the reliability of the AI model based on information collected while the AI model is executed on the digital twin network.

### CROSS-REFERENCE TO RELATED APPLICATION

The present application claims priority to Patent Application No. 10-2022-0164924, filed on in Korea Intellectual Property Office on Nov. 30, 2022, the entire contents of which are incorporated herein by reference.

### TECHNICAL FIELD

The present disclosure relates to an apparatus and method for evaluating the reliability of an AI/ML model.

### BACKGROUND

As artificial intelligence/machine learning (AI/ML) technology continues to evolve, it is also being integrated into the realm of network technology. In the autonomous network based on the AI/ML technology, limited resources may be utilized efficiently as the maintenance of complex network infrastructure is automated.

Intelligent network functions enhanced from existing rule-based network functions by employing AI/ML models may predict services relevant to emerging use cases or requirements by leveraging ultra-low latency and high-bandwidth networks and may perform optimization of service quality.

Current AI/ML models may not readily explain the causal relationships underlying inference results generated by a learning process. In particular, the performance measurement results of a trained model may vary depending on the timing of its training and actual deployment. Moreover, malfunctions of a learning model undetected during the test phase of the learning model may manifest in the actual environment due to errors introduced during the development of the learning model with a complex structure and problems originating from data input during the inference phase.

### SUMMARY

One embodiment of the present disclosure provides a method for evaluating the reliability of an AI/ML model.

Another embodiment of the present disclosure provides a method for evaluating the reliability of an AI/ML model.

Yet another embodiment of the present disclosure provides a method for forwarding traffic for evaluating the reliability of an AI/ML mode.

According to an embodiment of the present disclosure, a method of for verifying reliability of an artificial intelligence (AI) model includes receiving an AI model request; creating a verification twin for evaluating the reliability of the AI model; and verifying the reliability of the AI model based on information collected while the AI model is executed on the digital twin network.

According to an embodiment of the present disclosure, a method for forwarding traffic to a digital twin network for verifying reliability of an artificial intelligence (AI) model includes receiving a request for forwarding traffic of an actual network to the digital twin network; duplicating the traffic of the actual network; and forwarding the duplicated traffic to the digital twin network.

According to an embodiment of the present disclosure, an apparatus for verifying reliability of an artificial intelligence (AI) model includes a processor, a memory, and a communication device, wherein the processor executes a program stored in the memory to perform: receiving the AI model request; creating a digital twin network for evaluating the reliability of the AI model; and verifying the reliability of the AI model based on information collected while the AI model is executed on the digital twin network.

According to an embodiment of the present disclosure, an apparatus for verifying reliability of an artificial intelligence (AI) model includes a processor, a memory, and a communication device, wherein the processor executes a program stored in the memory to perform: receiving a reliability verification request of the AI model; creating a digital twin network for evaluating the reliability of the AI model; when the digital twin network is created, requesting a device which has sent the reliability verification request to provide the AI model; and verifying the reliability of the AI model based on information collected while the AI model is executed on the digital twin network.

The AI/ML model's inference and optimal control may be verified through utilization of both the traffic from a digital twin network replicating the real-world environment to which the AI/ML model is applied and the traffic from the actual network.

If the reliability of AI/ML model evaluation results is improved by the apparatus for verifying the reliability of an AI/ML model according to the present disclosure, components of a core network may directly use the results at the level of control command generated by the AI/ML model, and the apparatus may be used as a key technique to the wide spread of the future 6G network fully integrated with AI.

### BRIEF DESCRIPTION OF THE DRAWINGS

FIG. 1 shows a block diagram of a system for verifying the reliability of an AI/ML model according to one embodiment.

FIG. 2 is a flow diagram illustrating a method for verifying the reliability of an AI/ML model according to one embodiment.

FIG. 3 shows a block diagram of a system for verifying the reliability of an AI/ML model according to another embodiment.

FIG. 4 is a flow diagram illustrating a method for verifying the reliability of an AI/ML model according to another embodiment.

FIG. 5 is a conceptual diagram illustrating a method for replicating network traffic of an actual network by the PCF, SMF, and UPF and forwarding the duplicated network traffic to a digital twin network according to one embodiment.

FIG. 6 shows a block diagram of a system for verifying the reliability of an AI/ML model according to yet another embodiment.

FIG. 7 is a flow diagram illustrating a method for verifying the reliability of an AI/ML model according to yet another embodiment.

FIG. 8 shows a block diagram of a system for verifying the reliability of an AI/ML model according to still another embodiment.

FIG. 9 is a flow diagram illustrating a method for verifying the reliability of an AI/ML model according to still another embodiment.

FIG. 10 is a flow diagram illustrating a method for verifying the reliability of an AI/ML model according to yet still another embodiment.

FIG. 11 shows a block diagram of a system for verifying the reliability of an AI/ML model according to yet still another embodiment.

FIG. 12 is a flow diagram illustrating a method for verifying the reliability of an AI/ML model according to still yet another embodiment.

FIG. 13 shows a block diagram of a system for verifying the reliability of an AI/ML model according to still yet another embodiment.

FIG. 14 is a flow diagram illustrating a method for verifying the reliability of an AI/ML model according to yet further another embodiment.

FIG. 15 shows a block diagram of a system for verifying the reliability of an AI/ML model according to yet further another embodiment.

FIG. 16 is a flow diagram illustrating a method for verifying the reliability of an AI/ML model according to still further another embodiment.

FIG. 17 shows a block diagram of a system for verifying the reliability of an AI/ML model according to still further another embodiment.

FIG. 18 is a flow diagram illustrating a method for verifying the reliability of an AI/ML model according to yet still further another embodiment.

FIG. 19 is a flow diagram illustrating a method for verifying the reliability of an AI/ML model according to still yet further another embodiment.

FIG. 20 shows a block diagram of a system for verifying the reliability of an AI/ML model according to yet still further another embodiment.

FIG. 21 is a flow diagram illustrating a method for verifying the reliability of an AI/ML model according to even yet another embodiment.

FIG. 22 is a flow diagram illustrating a method for verifying the reliability of an AI/ML model according to even still another embodiment.

FIG. 23 is a flow diagram illustrating a method for verifying the reliability of an AI/ML model according to even yet another embodiment.

FIG. 24 is a flow diagram illustrating a method for verifying the reliability of an AI/ML model according to even yet still another embodiment.

FIG. 25 is a flow diagram illustrating a method for verifying the reliability of an AI/ML model according to even still yet another embodiment.

FIG. 26 is a flow diagram illustrating a method for verifying the reliability of an AI/ML model according to yet still even another embodiment.

FIG. 27 illustrates an apparatus for verifying the reliability of an AI/ML model according to one embodiment.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

The following detailed description is intended to describe exemplary embodiments of the present invention and is not intended to represent the only embodiments in which the present invention may be practiced.

Throughout the disclosure, the terminal may refer to a user equipment (UE), a mobile station (MS), a mobile terminal (MT), an advanced mobile station (AMS), a high reliability mobile station (HR-MS), a subscriber station (SS), a portable subscriber station (PSS), an access terminal (AT), or a machine type communication (MTC) device; the terminal may include all or part of the functions of the UE, MS, MT, AMS, HR-MS, SS, PSS, and AT.

Similarly, a base station (BS) may refer to a node B, an evolved node B (eNB), a gNB, an advanced base station (ABS), a high reliability base station (HR-BS), an access point (AP), a radio access station (RAS), a base transceiver station (BTS), a mobile multihop relay (MMR)-BS, a relay station (RS) that serves as a base station, a relay node (RN) that serves as a base station, an advanced relay station ARS) that serves as a base station, a high reliability relay station (HR-RS) that serves as a base station, a small-scale base station (femto-BS), a home node B (HNB), a hone eNodeB (HeNB), a pico base station (pico BS), a macro base station (macro BS), or a micro base station (micro BS); the BS may include all or part of the functions of the NB, eNB, gNB, ABS, AP, RAS, BTS, MMR-BS, RS, RN, ARS, HR-RS, and small-scale base station.

Throughout the present disclosure, unless otherwise explicitly stated, if a particular element is said to “include” some particular element, it means that the former may further include other particular elements rather than exclude them.

In the present disclosure, each of the expressions like “A or B,” “at least one of A and B,” or “at least one of A or B,” “A, B, or C,” “at least one of A, B, and C,” and “at least one of A, B, or C” may include any one of items listed together in the corresponding expression or all possible combinations of the items listed together.

In the present disclosure, expressions written in the singular form may be construed as encompassing both singular and plural interpretations unless explicitly accompanied by terms such as “one” or “single.”

In the present disclosure, the term “and/or” includes each individual constituting element mentioned and every possible combination involving one or more of the constituting elements.

Also, terms including an ordinal number such as first or second may be used to describe various constituting elements of the present disclosure, but the constituting elements should not be limited by these terms. Those terms are used only for the purpose of distinguishing one constituting element from the others. For example, without departing from the technical scope of the present disclosure, a first constituting element may be called a second constituting element and vice versa.

In the flow diagrams described with reference to the appended drawings of the present disclosure, the sequence of operations may be changed, a plurality of operations may be consolidated, some operations may be divided, and a specific operation may not be performed.

An embodiment of the present disclosure is a network implementation based on an AI model. The AI model may be a model based on machine learning (ML). The ML may include traditional machine learning and deep learning. In the present disclosure, AL model based on machine learning may be referred to as an AL/ML model or an ML model.

In the present disclosure, it is essential to evaluate the reliability of an AI/ML model before the trained AI/ML model is deployed to an actual network. To this end, key issues for assessing the correctness of machine learning (ML) models provided by the network data analytics function (NWDAF) and solutions for the key issues are being discussed. Among the sub-functions of the NWDAF, the evaluation of the ML model may be carried out by one of the Machine Learning Training Logical Function (MTLF) responsible for model learning, the Analytic Logical Function (AnLF) responsible for inference, or the Consumer NF which employs the analytics provided by the NWDAF.

A system is also proposed where the ML sandbox subsystem evaluates the ML effect before the network operator deploys the ML output to a live network. Here, data generated from a simulated ML underlay network may be used to train and test the model.

To implement AI for networks and networks for AI, pre-evaluation of AI/ML models may be a prerequisite for the close integration of network and AI technologies in the future mobile network. In this regard, digital twin techniques may be needed as testbeds to test trained AI/ML models.

In the present disclosure, an AI/ML model may refer to AI/ML algorithms, architecture, parameters, and operating platform and may include data, information, and the environment required for inference involving the AI/ML model.

In the present disclosure, reliability evaluation may include evaluation of the performance evaluation metric of the AI/ML model and evaluation of the operational stability evaluation metric; the performance evaluation metric may be set differently according to the AI/ML model, inference result formats, and requirements of AI consumers.

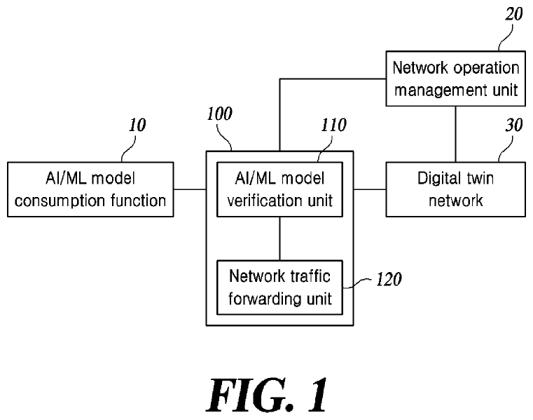

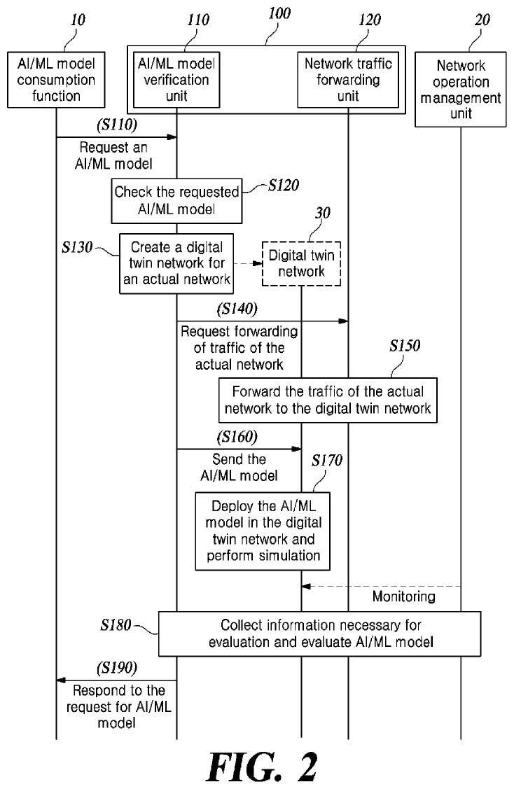

FIG. 1 shows a block diagram of a system for verifying the reliability of an AI/ML model according to one embodiment, and FIG. 2 is a flow diagram illustrating a method for verifying the reliability of an AI/ML model according to one embodiment.

Referring to FIG. 1, the system for verifying the reliability of an AI/ML model according to one embodiment may include an AI/ML model consumption function 10 that requires an AI/ML model, a reliability verification apparatus 100 for supplying and verifying the AI/ML model to be used in the AI/ML model consumption function 10, and a network operation management unit 20. The apparatus 100 for verifying the reliability of an AI/ML model may include an AI/ML model verification unit 110 and a network traffic forwarding unit 120.

The apparatus 100 for verifying the reliability of an AI/ML model may be operated in the actual network environment and may verify the reliability of an AI/ML model to be deployed or embedded in the AI/ML model consumption function 10. The AI/ML model verification unit 110 may develop, learn, and train an AI/ML model and

evaluate the reliability of the AI/ML model by evaluating the AI/ML model according to a performance evaluation metric or an operational stability evaluation metric. Afterward, the AI/ML model verification unit 110 may provide the AI/ML model whose reliability has been verified to the AI/ML model consumption function 10.

To verify the reliability of the AI/ML model, the network traffic forwarding unit 120 duplicates the entire or a portion of the network traffic from the actual network environment in which the AI/ML model is to be deployed and operated; the duplicated network traffic is forwarded to the digital twin network 30 that replicates the whole or part of the actual network environment.

The network operation management unit 20 may monitor the actual network environment and the environment of the digital twin network 30.

Referring to FIG. 2, the AI/ML model consumption function 10 may request an AI/ML model from the AI/ML model verification unit 110 S110. The AI/ML model request raised by the AI/ML model consumption function 10 may include network configuration reference information and parameters for evaluating the reliability of the AI/ML model. In one embodiment, the parameters for evaluating the reliability of the AI/ML model may include a performance evaluation metric and an operational stability evaluation metric of the AI/ML model, an evaluation duration, and/or an evaluation period.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)) from which information on the actual network may be obtained.

The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering instances constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the Mean Absolute Error (MAE), Mean Absolute Percentage Error (MAPE), Mean Squared Error (MSE), and Root Mean Squared Error (RMSE) utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. In one embodiment, the operational stability performance metric of the AI/ML model may include indicators such as availability, security, scalability, and whether inference time is within an acceptable range.

The AI/ML model verification unit 110 may check the requested AI/ML model S120. In one embodiment, the AI/ML model verification unit 110 may check the presence of the requested AI/ML model and create one by training a new AI/ML model in the absence of the requested AI/ML model.

When the presence of the requested AI/ML model is confirmed, the AI/ML model verification unit 110 may create a twin network that replicates the actual network based on the network configuration reference information received from the AI/ML model consumption function 10 S130.

The AI/ML model verification unit 110 may collect data required for the configuration of the twin network and generate snapshots and images of the actual network based on the collected data. Generating a snapshot of the actual network is a technique used to generate a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the AI/ML model verification unit 110 may execute the digital twin network 30 that replicates the actual network by using the snapshot and image of the actual network. Each constituting element of the digital twin network 30 may be executed as a twin instance, and the digital twin network 30 may be operated in synchronization with the actual network using the same configurations and data applied to the individual constituting elements of the actual network.

The AI/ML model verification unit 110 may request the network traffic forwarding unit 120 to perform generation of a forwarding policy and traffic forwarding for mirroring the traffic of the actual network (duplication of the actual network traffic and forwarding of the duplicated traffic to the digital twin network 30) S140.

The AI/ML model verification unit 110 may send the traffic forwarding reference information to the network traffic forwarding unit 120 when requesting the generation of the forwarding policy and traffic forwarding. The traffic forwarding reference information may include the identifier of an entity (e.g., the AI/ML model verification unit 110) requesting the generation of the forwarding policy, the identifier of a target endpoint to which filtered data is forwarded according to the forwarding policy and the address of the target endpoint (which is included within the digital twin network 30), and a data filter context identifier.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a protocol data unit (PDU) session ID, single-network slice selection assistance information (S-NSSAI), data network name (DNN), radio access technology (RAT) type, an internal group identifier, network area information, a media access control (MAC) address of the target endpoint or IP 3-tuple (destination IP, destination port, protocol) information, packet filters for PDU sessions, related routing profile IDs, or N6 traffic routing information.

When the network traffic forwarding unit 120 generate a packet data forwarding policy based on the traffic forwarding reference information received from the AI/ML model verification unit 110 and sends the generated packet data forwarding policy to the user plane function (UPF), the UPF may forward the traffic of the actual network to the digital twin network based on the packet data forwarding policy S150.

Alternatively, the network traffic forwarding unit 120 may generate a data forwarding rule such as the packet detection rule (PDR) and the forwarding action rule (FAR) based on the generated packet data forwarding policy and send the data forwarding rule to the UPF. In one embodiment, the PDR generated by the network traffic forwarding unit 120 may include parameters related to packet duplication. The FAR generated by the network traffic forwarding unit 120 may include parameters related to packet duplication instruction.

The UPF may filter the packet data to be sent to the digital twin network 30 according to the PDR, duplicate the packet data identified by the filtering, and forward the duplicated packet data to the target endpoint within the digital twin network according to the FAR. The UPF may identify the mirroring requirements of the network traffic forwarding unit 120 from the parameters related to packet duplication in the PDR and/or the parameters related to the packet duplication instruction in the FAR, duplicate the filtered packet data, and forward the duplicated packets to the target end.

The AI/ML model verification unit 110 may send the AI/ML model, which is a reliability evaluation target, to the digital twin network 30 S160. In one embodiment, the AI/ML model verification unit 110 may send the AI/ML model to a twin instance (target twin instance) supposed to use the AI/ML model among twin instances in the digital twin network. The target twin instance may be a twin instance mapped to the AI/ML model consumption function 10 in the actual network.

The digital twin network 30 may deploy the AI/ML model and perform simulation using the traffic forwarded from the actual network S170. In other words, the target twin instance may perform inference by deploying the sent AI/ML model and providing the signal generated from the digital twin network 30 and forwarded duplicated traffic to the AI/ML model.

When the digital twin network 30 in which the AI/ML model has been deployed starts simulation using the AI/ML model, the AI/ML model verification unit 110 may evaluate the AI/ML model based on the performance evaluation metric and the operational stability evaluation metric received from the AI/ML model consumption function 10 S180. The AI/ML model verification unit 110 may collect necessary information from twin instances within the digital twin network 30 through the network operation management unit 20 and/or from the actual network to measure the performance evaluation metric and the operational stability evaluation metric.

Once the information is collected, the AI/ML model verification unit 110 may evaluate the AI/ML model using the performance evaluation metric and the operational stability evaluation metric and generate an evaluation result. When an internal policy is given in advance for the evaluation period and duration, or the entity requesting evaluation specifies the evaluation period and duration, the AI/ML model verification unit 110 may perform evaluations periodically throughout the specified evaluation duration.

When a reliability evaluation result is generated, the AI/ML model verification unit 110 may send the AI/ML model and the evaluation result for the corresponding AI/ML model to the AI/ML model consumption function 10 S190.

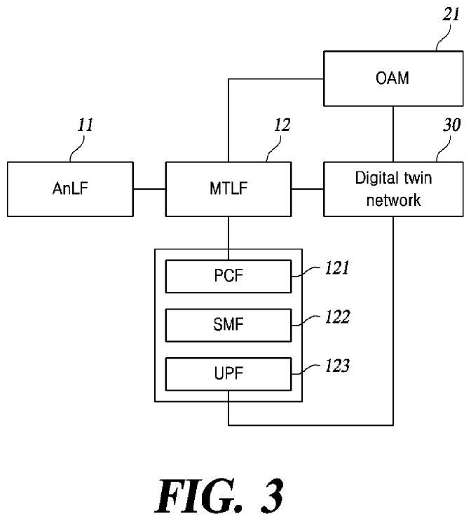

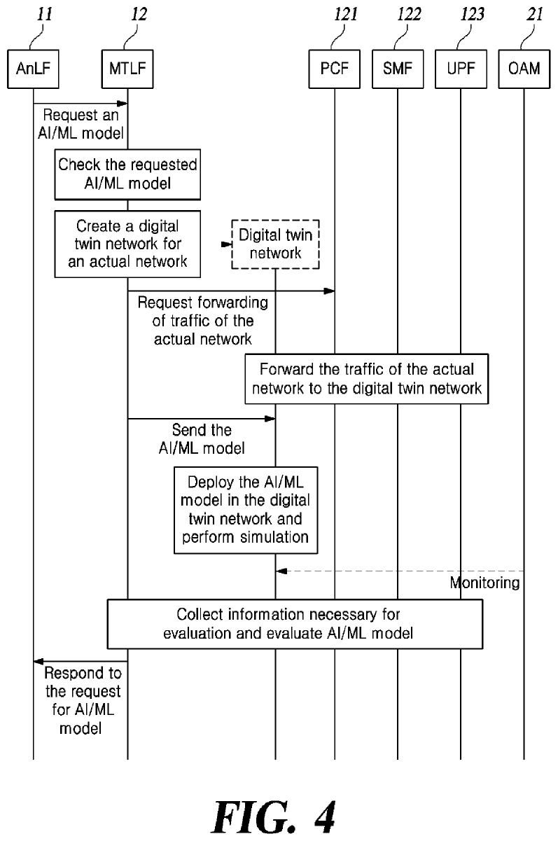

FIG. 3 shows a block diagram of a system for verifying the reliability of an AI/ML model according to another embodiment, and FIG. 4 is a flow diagram illustrating a method for verifying the reliability of an AI/ML model according to another embodiment.

Referring to FIG. 3, a system for verifying the reliability of an AI/ML model according to another embodiment may include AnLF 11 that requires an AI/ML model, MTLF 12 for supplying and verifying the AI/ML model to be used in the AnLF 11, and OAM 21.

The AnLF 11 is operated in the actual network environment; an AI/ML model may be deployed in the AnLF 11. The AnLF 11 of FIG. 3 may be included in the NWDAF and correspond to the AI/ML model consumption function 10 of FIG. 1.

The MTLF 12 may create an AI/ML model and perform learning and training on the created AI/ML model. The MTLF 12 may be included within the NWDAF. Also, the MTLF 12 may verify the reliability of the AI/ML model by evaluating the AI/ML model according to a performance evaluation metric or an operational stability evaluation metric. The MTLF 12 may provide the AI/ML model and the reliability evaluation result of the corresponding AI/ML model to the AnLF 11 or NWDAF which includes the AnLF 11.

The digital twin network 30 may be created by the MTLF 12 to verify the reliability of the AI/ML model, which may be a replication of the entire or a portion of the actual network environment in which the AI/ML model is deployed and operated.

Network traffic forwarding of the reliability verification system shown in FIG. 3 may be performed by the policy control function (PCF) 121, the session management function (SMF) 122, and the UPF 123. In other words, the PCF 121, SMF 122, and UPF 123 of FIG. 3 may duplicate network traffic from the actual network environment, forward (i.e., mirror) the duplicated network traffic to the digital twin network 30, and perform the same function as the network traffic forwarding unit 120 of FIG. 1.

The PCF 121 may generate a policy for duplicating the entire or a portion of the network traffic of the actual network environment (a portion of the network traffic may be selected according to a predetermined policy) and forwarding the duplicated traffic to the digital twin network 30.

The SMF 122 may generate at least one rule to be applied to the UPF 123 according to the policy generated by the PCF 121 and send the generated rule to the UPF 123.

The UPF 123 may detect packet data according to the rule sent from the SMF 122, duplicate the detected packet data, and forward the duplicated packet data to the digital twin network 30.

The OAM 21 may monitor the actual network and the digital twin network 30.

FIG. 4 illustrates a method for verifying the reliability of an AI/ML model by the MTLF 12 according to one embodiment.

The AnLF 11 may request an AI/ML model from the MTLF 12 S210. Here, the AnLF 11 and the MTLF 12 may belong to different NWDAFs. The MTLF 12 may receive evaluation-related parameters for evaluating the AI/ML model, such as the network configuration reference information, the performance evaluation metric and the operational stability evaluation metric of the AI/ML model, evaluation duration, and evaluation period, from the AnLF 11 or the NWDAF including the AnLF 11.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the MAE, MAPE, MSE, and RMSE utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. To evaluate the operational stability of the AI/ML model, operational stability performance metrics, such as availability, security, scalability, and an indicator indicating whether inference time is within an acceptable range may be used.

The MTLF 12 which has received an AI/ML model request from the AnLF 11 may check the requested AI/ML model S220. The MTLF 12 may check the presence of the requested AI/ML model and create one by training a new AI/ML model in the absence of the requested AI/ML model.

When the presence of the requested AI/ML model is confirmed, the MTLF 12 may create a twin network that replicates the actual network based on the network configuration reference information received from the AnLF 11 S230.

The MTLF 12 may collect data required for the configuration of the twin network and generate snapshots and images of the actual network based on the collected data. Generating a snapshot of the actual network is a technique used to create a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the MTLF 12 may execute the digital twin network 30 that replicates the actual network by using the snapshot and image of the actual network. Each constituting element of the digital twin network 30 may be executed as a twin instance, and the digital twin network 30 may be operated in synchronization with the actual network using the same configurations and data applied to the individual constituting elements of the actual network.

The MTLF 12 may request the PCF 121 to perform generation of a forwarding policy and traffic forwarding for mirroring the traffic of the actual network (duplication of the actual network traffic and forwarding of the duplicated traffic to the digital twin network 30) S240.

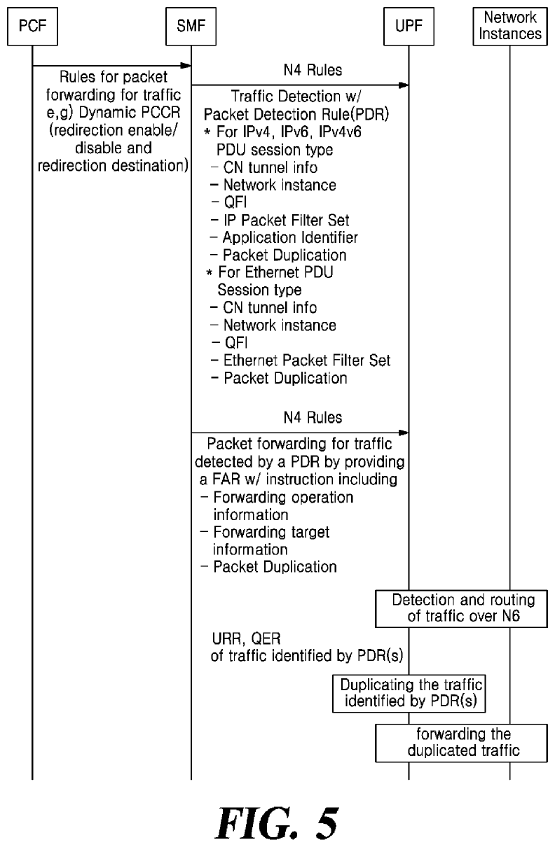

Afterward, the PCF 121, SMF 122, and UPF 123 may forward the traffic of the actual network to the digital twin network according to the request of the MTLF 12 S250. FIG. 5 is a conceptual diagram illustrating a method for replicating network traffic of an actual network by the PCF 121, SMF 122, and UPF 123 and forwarding the duplicated network traffic to a digital twin network.

The MTLF 12 may send the traffic forwarding reference information to the PCF 121 when requesting the generation of the forwarding policy and traffic forwarding. The traffic forwarding reference information may include the identifier of an entity (e.g., the NWDAF including the MTLF 12) requesting the generation of the forwarding policy, the identifier of a target endpoint to which filtered data is forwarded according to the forwarding policy and the address of the target endpoint (which is included within the digital twin network 30), and a data filter context identifier.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a PDU session ID, S-NSSAI, DNN, RAT type, an internal group identifier, network area information, a MAC address of the target endpoint or IP 3-tuple (destination IP, destination port, protocol) information, packet filters for PDU sessions, related routing profile IDs, or N6 traffic routing information.

The PCF 121 may generate a packet data forwarding policy based on the traffic forwarding reference information received from the MTLF 12. The PCF 121 may send the generated packet data forwarding policy to the SMF 122.

The SMF 122 may generate a data forwarding rule such as the PDR and the FAR based on the generated packet data forwarding policy and send the data forwarding rule to the UPF 123. In one embodiment, the PDR may include parameters related to packet duplication, and the FAR may include parameters related to packet duplication instruction. The UPF may identify the mirroring requirements of the SMF 122 from the parameters related to packet duplication within the PDR and/or the parameters related to the packet duplication instruction within the FAR, duplicate filtered packet data, and forward the duplicated packets to the target endpoint.

In one embodiment, the PDR may include information such as the Internet Protocol version 4 (IPv4), Internet Protocol version 6 (IPv6), and IPv4v6-based core network (CN) tunnel information on the PDU session type, network Instance, quality of service (QOS) flow identifier (QFI), IP packet filter set, application identifier, S-NSSAI, a UE identifier, a group of UEs, a random UE, and whether packet data is duplicated. For the Ethernet-based PDU session type, the PDR may include information such as the CN tunnel information, network instance, QFI, Ethernet packet filter set, S-NSSAI, a UE identifier, a group of UEs, a random UE, and whether packet data is duplicated. The FAR may include information such as forwarding operation information, forwarding target information, and whether the packet data is duplicated.

The UPF 123 may filter the packet data to be sent to the digital twin network 30 according to the PDR, duplicate the packet data identified by the filtering, and forward the duplicated packet data to the target endpoint within the digital twin network according to the FAR.

The MTLF 12 may send the AI/ML model, which is a reliability evaluation target, to the digital twin network 30 S260. In one embodiment, the MTLF 12 may send the AI/ML model to a target twin instance (the twin instance of NWDAF in which the AnLF 11 is included) supposed to use the AI/ML model among twin instances in the digital twin network. The target twin instance may be a twin instance mapped to the AnLF 11 in the actual network.

The twin instance of NWDAF in which the AnLF 11 is included may deploy the AI/ML model and perform simulation using the traffic forwarded from the actual network S270. In other words, the target twin instance may perform inference by deploying the sent AI/ML model and providing the signal generated from the digital twin network 30 and forwarded duplicated traffic to the AI/ML model.

When the digital twin network 30 in which the AI/ML model has been deployed starts simulation using the AI/ML model, the MTLF 12 may evaluate the AI/ML model based on the performance evaluation metric and the operational stability evaluation metric received from the AnLF 11 or the NWDAF in which the AnLF 11 is included S280. The MTLF 12 may collect necessary information from twin instances within the digital twin network 30 through the OAM 21 and/or from the actual network to measure the performance evaluation metric and the operational stability evaluation metric.

Once the information is collected, the MTLF 12 may evaluate the AI/ML model using the performance evaluation metric and the operational stability evaluation metric and generate an evaluation result. When an internal policy is given in advance for the evaluation period and duration, or the entity requesting evaluation specifies the evaluation period and duration, the MTLF 12 may perform evaluations periodically throughout the specified evaluation duration.

When a reliability evaluation result is generated, the MTLF 12 may send the AI/ML model and the evaluation result for the corresponding AI/ML model to the AnLF 11 or the NWDAF in which the AnLF 11 is included S290.

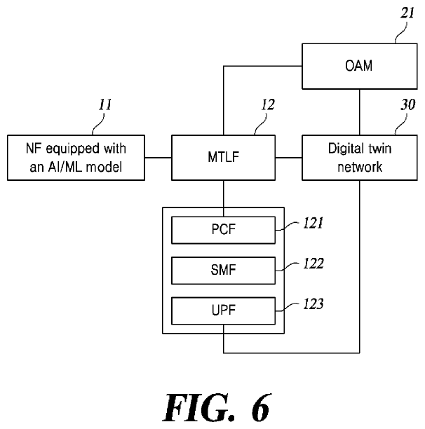

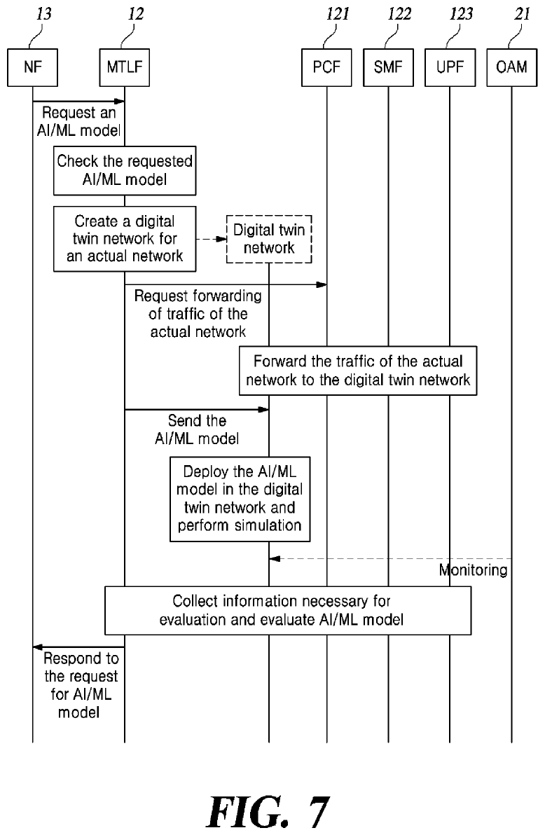

FIG. 6 shows a block diagram of a system for verifying the reliability of an AI/ML model according to yet another embodiment, and FIG. 7 is a flow diagram illustrating a method for verifying the reliability of an AI/ML model according to yet another embodiment.

Referring to FIG. 6, a system for verifying the reliability of an AI/ML model according to yet another embodiment may include NF 13 that requires an AI/ML model, MTLF 12 for supplying and verifying the AI/ML model to be used in the NF 13, and OAM 21.

In FIG. 6, an AI/ML model may be embedded in the NF 13. The NF 13 may be operated in the actual network environment; with an AI/ML model deployed in the NF 13, the NF 13 may directly use the inference result generated by the AI/ML model.

The MTLF 12 or the NWDAF in which the MTLF 12 is included may create, teach, and train an AI/ML model and verify the reliability of the AI/ML model by evaluating the performance evaluation metric and the operational stability evaluation metric. The MTLF 12 may provide an AI/ML model whose reliability has been verified to the NF with embedded AI.

Network traffic forwarding of the reliability verification system shown in FIG. 6 may be performed by the PCF 121, SMF 122, and UPF 123. In other words, the PCF 121, SMF 122, and UPF 123 of FIG. 6 may duplicate network traffic from the actual network environment, forward (i.e., mirror) the duplicated network traffic to the digital twin network 30, and perform the same function as the network traffic forwarding unit 120 of FIG. 1.

The PCF 121 may generate a policy for duplicating the entire or a portion of the network traffic of the actual network environment (a portion of the network traffic may be selected according to a predetermined policy) and forwarding the duplicated traffic to the digital twin network 30.

The SMF 122 may generate at least one rule to be applied to the UPF 123 according to the policy generated by the PCF 121 and send the generated rule to the UPF 123.

The UPF 123 may detect packet data according to the rule sent from the SMF 122, duplicate the detected packet data, and forward the duplicated packet data to the digital twin network 30.

The OAM 21 may monitor the actual network and the digital twin network 30.

FIG. 7 illustrates a method for verifying the reliability of an AI/ML model by the MTLF 12 according to yet another embodiment.

Referring to FIG. 7, the NF 13 may request an AI/ML model from the MTLF 12 S310. The MTLF 12 may receive evaluation-related parameters for evaluating the AI/ML model, such as the network configuration reference information, the performance evaluation metric and the operational stability evaluation metric of the AI/ML model, evaluation duration, and evaluation period, from the NF 13.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the MAE, MAPE, MSE, and RMSE utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. To evaluate the operational stability of the AI/ML model, operational stability performance metrics, such as availability, security, scalability, and an indicator indicating whether inference time is within an acceptable range may be used.

The MTLF 12 which has received an AI/ML model request from the NF 13 may check the requested AI/ML model S320. The MTLF 12 may check the presence of the requested AI/ML model and create one by training a new AI/ML model in the absence of the requested AI/ML model.

When the presence of the requested AI/ML model is confirmed, the MTLF 12 may create a twin network that replicates the actual network based on the network configuration reference information received from the NF 13 S330.

The MTLF 12 may collect data required for the configuration of the twin network and generate snapshots and images of the actual network based on the collected data. Generating a snapshot of the actual network is a technique used to create a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the MTLF 12 may execute the digital twin network 30 that replicates the actual network by using the snapshot and image of the actual network. Each constituting element of the digital twin network 30 may be executed as a twin instance, and the digital twin network 30 may be operated in synchronization with the actual network using the same configurations and data applied to the individual constituting elements of the actual network.

The MTLF 12 may request the PCF 121 to perform generation of a forwarding policy and traffic forwarding for mirroring the traffic of the actual network (duplication of the actual network traffic and forwarding of the duplicated traffic to the digital twin network 30) S340.

Afterward, the PCF 121, SMF 122, and UPF 123 may forward the traffic of the actual network to the digital twin network according to the request of the MTLF 12 S350. FIG. 5 is a conceptual diagram illustrating a method for replicating network traffic of an actual network by the PCF 121, SMF 122, and UPF 123 and forwarding the duplicated network traffic to a digital twin network.

The MTLF 12 may send the traffic forwarding reference information to the PCF 121 when requesting the generation of the forwarding policy and traffic forwarding. The traffic forwarding reference information may include the identifier of an entity (e.g., the NWDAF including the MTLF 12) requesting the generation of the forwarding policy, the identifier of a target endpoint to which filtered data is forwarded according to the forwarding policy and the address of the target endpoint (which is included within the digital twin network 30), and a data filter context identifier.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a PDU session ID, S-NSSAI, DNN, RAT type, an internal group identifier, network area information, a MAC address of the target endpoint or IP 3-tuple (destination IP, destination port, protocol) information, packet filters for PDU sessions, related routing profile IDs, or N6 traffic routing information.

The PCF 121 may generate a packet data forwarding policy based on the traffic forwarding reference information received from the MTLF 12. The PCF 121 may send the generated packet data forwarding policy to the SMF 122.

The SMF 122 may generate a data forwarding rule such as the PDR and the FAR based on the generated packet data forwarding policy and send the data forwarding rule to the UPF 123. In one embodiment, the PDR may include parameters related to packet duplication, and the FAR may include parameters related to packet duplication instruction. The UPF may identify the mirroring requirements of the SMF 122 from the parameters related to packet duplication within the PDR and/or the parameters related to the packet duplication instruction within the FAR, duplicate filtered packet data, and forward the duplicated packets to the target endpoint.

In one embodiment, the PDR may include information such as the Internet Protocol version 4 (IPv4), Internet Protocol version 6 (IPv6), and IPv4v6-based core network (CN) tunnel information on the PDU session type, network Instance, quality of service (QOS) flow identifier (QFI), IP packet filter set, application identifier, S-NSSAI, a UE identifier, a group of UEs, a random UE, and whether packet data is duplicated. For the Ethernet-based PDU session type, the PDR may include information such as the CN tunnel information, network instance, QFI, Ethernet packet filter set, S-NSSAI, a UE identifier, a group of UEs, a random UE, and whether packet data is duplicated. The FAR may include information such as forwarding operation information, forwarding target information, and whether the packet data is duplicated.

The UPF 123 may filter the packet data to be sent to the digital twin network 30 according to the PDR, duplicate the packet data identified by the filtering, and forward the duplicated packet data to the target endpoint within the digital twin network according to the FAR.

The MTLF 12 may send the AI/ML model, which is a reliability evaluation target, to the digital twin network 30 S360. In one embodiment, the MTLF 12 may send the AI/ML model to a target twin instance (the twin instance in which the NF 13 is included) supposed to use the AI/ML model among twin instances in the digital twin network. The target twin instance may be a twin instance mapped to the NF 13 in the actual network.

The twin instance in which the NF 13 is included may deploy the AI/ML model and perform simulation using the traffic forwarded from the actual network S370. In other words, the target twin instance may perform inference by deploying the sent AI/ML model and providing the signal generated from the digital twin network 30 and forwarded duplicated traffic to the AI/ML model.

When the digital twin network 30 in which the AI/ML model has been deployed starts simulation using the AI/ML model, the MTLF 12 may evaluate the AI/ML model based on the performance evaluation metric and the operational stability evaluation metric received from the NF 13 S380. The MTLF 12 may collect necessary information from twin instances within the digital twin network 30 through the OAM 21 and/or from the actual network to measure the performance evaluation metric and the operational stability evaluation metric.

Once the information is collected, the MTLF 12 may evaluate the AI/ML model using the performance evaluation metric and the operational stability evaluation metric and generate an evaluation result. When an internal policy is given in advance for the evaluation period and duration, or the entity requesting evaluation specifies the evaluation period and duration, the MTLF 12 may perform evaluations periodically throughout the specified evaluation duration.

When a reliability evaluation result is generated, the MTLF 12 may send the AI/ML model and the evaluation result for the corresponding AI/ML model to the NF 13 S390.

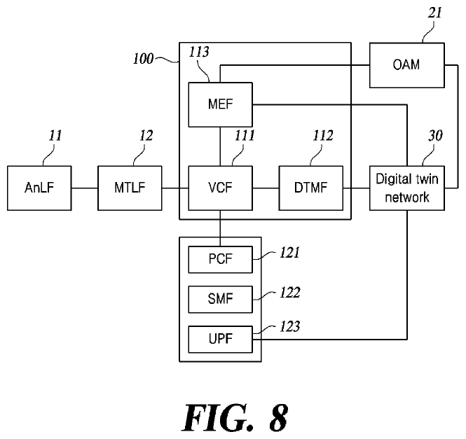

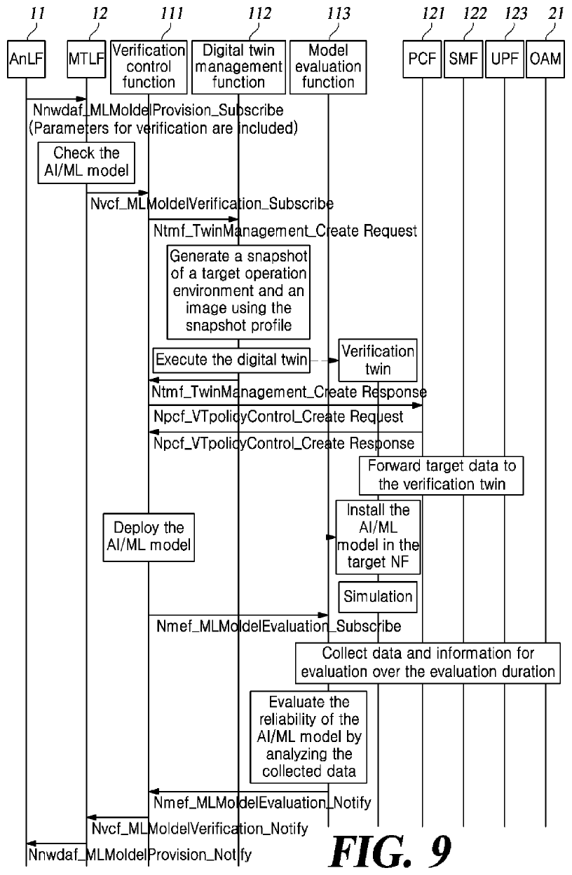

FIG. 8 shows a block diagram of a system for verifying the reliability of an AI/ML model according to still another embodiment, and FIG. 9 is a flow diagram illustrating a method for verifying the reliability of an AI/ML model according to still another embodiment.

Referring to FIG. 8, a system for verifying the reliability of an AI/ML model according to still another embodiment may include AnLF 11 that requires an AI/ML model, MTLF 12 for supplying the AI/ML model to be used in the AnLF 11, a reliability verification apparatus 100, and OAM 21.

The AnLF 11 is operated in the actual network environment; an AI/ML model may be deployed in the AnLF 11. The AnLF 11 of FIG. 8 may be included in the NWDAF and correspond to the AI/ML model consumption function 10 of FIG. 1.

After receiving the AI/ML model request from the AnLF 11, the MTLF 12 may create an AI/ML model and perform learning and training on the created AI/ML model. The MTLF 12 may request the reliability verification apparatus 100 to verify the created AI/ML model and provide the AI/ML model which has been verified by the reliability verification apparatus 100 to the AnLF 11. The MTLF 12 may be included in the NWDAF, and the NWDAF including the MTLF 12 may be the same as or different from the NWDAF including the AnLF 11. Also, the MTLF 12 may verify the reliability of the AI/ML model by evaluating the AI/ML model according to a performance evaluation metric or an operational stability evaluation metric. The MTLF 12 may provide the AI/ML model and the reliability evaluation result of the corresponding AI/ML model to the AnLF 11 or NWDAF which includes the AnLF 11.

The verification control function (VCF) 111 of the reliability verification apparatus 100 may receive a request for reliability evaluation of the AI/ML model from the MTLF 12 or from the NWDAF including the MTLF 12 and control a series of reliability evaluation procedures for the AI/ML model. The VCF 111 may request the digital twin management function (DTMF) 112 to create a digital twin network of the actual network to evaluate the reliability of the AI/ML model. When receiving a response from the DTMF 112, the VCF 111 may request the PCF 121 to perform forwarding of network traffic. When mirrored network traffic is forwarded to the digital twin network, the VCF 111 may request the model evaluation function MEF 113 to evaluate the reliability of the AI/ML model deployed in the digital twin network.

When a digital twin network 30 is requested from the VCF 111, the DTMF 112 may generate the digital twin network 30 for the actual network. The digital twin network 30 may replicate the entire or a portion of the actual network environment in which the AI/ML model is deployed and operated.

When the VCF 111 requests reliability evaluation of the AI/ML model deployed in the digital twin network, the MEF 113 may evaluate the reliability of the AI/ML model deployed in the digital twin network.

Network traffic forwarding of the reliability verification system shown in FIG. 8 may be performed by the PCF 121, the SMF 122, and the UPF 123. In other words, the PCF 121, SMF 122, and UPF 123 of FIG. 8 may duplicate network traffic from the actual network environment, forward (i.e., mirror) the duplicated network traffic to the digital twin network 30, and perform the same function as the network traffic forwarding unit 120 of FIG. 1.

The PCF 121 may generate a policy for duplicating the entire or a portion of the network traffic of the actual network environment (a portion of the network traffic may be selected according to a predetermined policy) and forwarding the duplicated traffic to the digital twin network 30.

The SMF 122 may generate at least one rule to be applied to the UPF 123 according to the policy generated by the PCF 121 and send the generated rule to the UPF 123.

The UPF 123 may detect packet data according to the rule sent from the SMF 122, duplicate the detected packet data, and forward the duplicated packet data to the digital twin network 30.

The OAM 21 may monitor the actual network and the digital twin network 30.

In still another embodiment, the reliability verification apparatus 100 may be a network function located in a network. When the reliability verification apparatus 100 operates as a reliability verification function in the network, the VCF 111, DTMF 112, and MEF 113 in the reliability verification apparatus 100 may operate as modules in the reliability verification function, and the operations of the VCF 111, DTMF 112, and MEF 113 may be implemented by at least one processor.

FIG. 9 illustrates a method for verifying the reliability of an AI/ML model by the reliability verification apparatus 100 according to still another embodiment.

Referring to FIG. 9, the AnLF 11 or the NWDAF including the AnLF 11 may request an AI/ML model from the MTLF 12 or the NWDAF including the MTLF 12 S405. In one embodiment, the AnLF 11 may request an AI/ML model from the MTLF 12 through Nnwdaf_MLMoldelProvision_Subscribe service operation. At this time, the network configuration reference information and evaluation-related parameters for evaluating the AI/ML model may be sent to the MTLF 12. The evaluation-related parameters for evaluating the AI/ML model may include the performance evaluation metric and the operational stability evaluation metric of the AI/ML model, evaluation duration, and evaluation period.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the MAE, MAPE, MSE, and RMSE utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. To evaluate the operational stability of the AI/ML model, operational stability performance metrics, such as availability, security, scalability, and an indicator indicating whether inference time is within an acceptable range may be used.

The MTLF 12 which has received an AI/ML model request from the AnLF 11 or the NWDAF including the AnLF 11 may check the requested AI/ML model S410. The MTLF 12 may check the presence of the requested AI/ML model and create one by training a new AI/ML model in the absence of the requested AI/ML model.

When the presence of the requested AI/ML model is confirmed, the MTLF 12 may request the VCF 111 to evaluate the reliability of the AI/ML model S415. When the MTLF 12 requests the VCF 111 to evaluate the reliability of the AI/ML model, the Nvcf_MLModelVerification_Subscribe service operation may be used. Table 1 below shows the parameters sent from the MTLF 12 to the VCF 111 through the Nvcf_MLModelVerification_Subscribe service operation. The information of Table 1 may be sent from the MTLF 12 to the VCF 111 or the reliability verification apparatus 100 through a different procedure.

TABLE 1

| | Parameters | Description |
|---|---|---|
| IN | ML Model ID | ML model identifier |
| | ML Model | ML model or storage location of the ML model |
| | or ML Model | (e.g., URL), |
| | Location | (Note: ML model includes information and |
| | | environment for model inference) |
| | ML Target NF, | NF to which the ML model is applied (ML model |
| | | consumption NF) |
| | Verification | Target environment to be composed of a |
| | twin Target- | verification twin (e.g., a network slice composed |
| | Environment | of NF instance and network function |
| | | virtualization (NFV)) |
| | | The entire core network including an ML target |
| | | NF if not explicitly specified |
| | Verification | Information for filtering service data flows to |
| | twin Target | be forwarded to the verification twin environment |
| | Data Filter | when the ML model is executed (e.g., UE, PDU |
| | | session, QoS flow, and network slice) |
| | | The entire data flow if not explicitly specified |
| | Evaluation | Metrics for evaluating an ML model |
| | Metrics | |
| | Evaluation | Provides an expectation value for each metric if |
| | Expectations | necessary |
| | Evaluation | Valid duration (for model evaluation) - Default |
| | Duration | value according to VCF policy if not explicitly |
| | | specified |
| | Evaluation | Evaluation period |
| | Period | |
| | Notification | Endpoint to which a notification due to |
| | End Point | subscription is sent |
| | | Subscriber if not explicitly specified |
| OUT | Subscription | ID for managing the subscription |
| | Correlation ID | |

The MTLF 12 may send information on the endpoint to which to send the meta information and evaluation results of the AI/ML model to be evaluated along with a reliability evaluation request. The meta information of the AI/ML model may include an identifier (ID) of the AI/ML model, the AI/ML model or the location where the AI/ML model is stored (e.g., URL), and information on the consumer NF of the AI/ML model. Also, the MTLF 12 may send the network configuration reference information and evaluation-related parameters of the AI/ML model received from the AnLF 11 to the VCF 111.

The VCF 111 may request the DTMF 112 to create a digital twin network for the operation of the AI/ML model S420. When the VCF 111 requests a digital twin network from the DTMF 112, the Ndtmf_TwinManagement_Create service operation may be used. Table 2 below shows the parameters sent from the VCF 111 to the DTMF 112 through the Ndtmf_TwinManagement_Create service operation. The information of Table 2 may be sent from the VCF 111 to the DTMF 112 through a different procedure.

TABLE 2

| | Parameters | Description |
|---|---|---|
| I | ML Target NF | NF to which AI/ML model is applied (AI/ML |
| | | model consumer NF) |
| | Target Operation | Target operation environment to be composed of |
| | Environment | verification twin |
| | | (The entire CN including NF to which AI/ML |
| | | model is deployed, if not explicitly specified) |
| | Target Data | Information for filtering service data to be |
| | Filter | forwarded to the verification twin environment |
| | | when the AI/ML model is executed (e.g., UEs, |
| | | PDU session, QoS flow, and network slice) |
| | | The entire data flow if not explicitly specified) |
| | Verification | Indicates whether to perform synchronization |
| | Twin Sync | when the target operation environment changes |
| | | while the verification twin is operated |
| | | (Not synchronized (false) if not explicitly |
| | | specified) |
| | Verification | When the Verification Twin Sync is set to true, |
| | Twin Sync | specifies components to be synchronized (e.g., |
| | Specification | NF configuration and rule) (follows the policy |
| | | set by the system operator, if not explicitly |
| | | specified) |
| O | Success or | Execution operation results |
| | Failure | |
| | Request | Reference identifier for the request |
| | Reference ID | |
| | Verification | Generated Verification Twin Identifier |
| | Twin Reference | |
| | ID | |

The DTMF 112 may collect data required for the configuration of the twin network based on the network configuration reference information received from the VCF 111 and generate snapshots and images of the actual network based on the collected data S425.

Generating a snapshot of the actual network is a technique used to create a new image 5 from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the DTMF 112 may execute the digital twin network 30 that replicates the actual network by using the snapshot image S430. Each constituting 10 element of the digital twin network 30 may be executed as a twin instance and may be operated with the same configuration as each individual constituting element and in synchronization with the data mapped to the actual network. After executing the digital twin network 30, the DTMF 112 may send Ndtmf_TwinManagement_Create response to the VCF 111.

The VCF 111 may request the PCF 121 to perform generation of a forwarding policy and traffic forwarding so that the traffic of the actual network is duplicated and forwarded to the digital twin network 30 S435. The VCF 111 may request the PCF 121 to perform generation of the forward policy and traffic forwarding by using Npcf_VTPolicyControl_Create service operation. Table 3 below shows the parameters sent from the VCF 111 to the PCF 121 through the Npcf_VTPolicyControl_Create service operation. The information of Table 3 may be sent from the VCF 111 to the PCF 121 through a different procedure.

TABLE 3

| | Parameters | Description |
|---|---|---|
| I | VCF identifier | ID of VCF which has requested policy generation |
| | Verification | Verification twin to which filtered data are |
| | twin identifier | forwarded according to the policy and ID and |
| | | address of a target endpoint within the |
| | | verification twin |
| | Data Filter | ID of context to be used to generate a policy for |
| | Context ID | filtering the data to be forwarded to the verification |
| | | twin |
| | | (Note: context may include PDU session id, |
| | | S-NSSAI, DNN, RAT type, Internal Group |
| | | Identifier, Network Area Information, MAC addr. |
| | | or IP 3-tuple of App. Server, packet filters for |
| | | the PDU Session, corresponding routing profile |
| | | ID(s) or N6 traffic routing information) |
| O | Success or | Execution operation results |
| | Failure | |
| | Policy | Policy ID |
| | Association ID | |

When generation of a forwarding policy and traffic forwarding are requested, the VCF 111 may send traffic forwarding reference information, such as the ID of an entity that requests generation of a forwarding policy, the ID and address of a target endpoint to which filtered data are forwarded according to the forwarding policy, and a data filter context identifier, to the PCF 121.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a PDU session ID, S-NSSAI, DNN, RAT type, an internal group identifier, network area information, a MAC address of the target endpoint or IP 3-tuple (destination IP, destination port, protocol) information, packet filters for PDU sessions, related routing profile IDs, or N6 traffic routing information.

The PCF 121 may generate a packet data forwarding policy based on the traffic forwarding reference information received from the VCF 111. The packet data forwarding policy generated by the PCF 121 may be sent to the SMF 122.

The SMF 122 may generate a data forwarding rule such as the PDR and the FAR based on the generated packet data forwarding policy and send the data forwarding rule to the UPF 123. In one embodiment, the PDR may include parameters related to packet duplication, and the FAR may include parameters related to packet duplication instruction. The UPF may identify the mirroring requirements of the SMF 122 from the parameters related to packet duplication within the PDR and/or the parameters related to the packet duplication instruction within the FAR, duplicate filtered packet data, and forward the duplicated packets to the target endpoint.

In one embodiment, the PDR may include information such as the Internet Protocol version 4 (IPv4), Internet Protocol version 6 (IPv6), and IPv4v6-based core network (CN) tunnel information on the PDU session type, network Instance, quality of service (QOS) flow identifier (QFI), IP packet filter set, application identifier, S-NSSAI, a UE identifier, a group of UEs, a random UE, and whether packet data is duplicated. For the Ethernet-based PDU session type, the PDR may include information such as the CN tunnel information, network instance, QFI, Ethernet packet filter set, S-NSSAI, a UE identifier, a group of UEs, a random UE, and whether packet data is duplicated. The FAR may include information such as forwarding operation information, forwarding target information, and whether the packet data is duplicated.

The UPF 123 may filter the packet data to be sent to the digital twin network 30 according to the PDR, duplicate the packet data identified by the filtering, and forward the duplicated packet data to the target endpoint within the digital twin network according to the FAR.

FIG. 5 illustrates a method for duplicating network traffic of the actual network and forwarding the duplicated network traffic to a digital twin network by the PCF 121, SMF 122, and UPF 123.

The VCF 111 may send the AI/ML model, which is a reliability evaluation target, to a twin instance within the digital twin network 30 S440. The VCF 111 may provide the AI/ML model to the twin instance within the digital twin network 30 based on the meta information of the AI/ML model received from the MTLF 12. The twin instance to which the AI/ML model is sent may be a twin instance supposed to use the AI/ML model (NWDAF twin instance including the AnLF) or a twin instance mapped to the AnLF 11 in the actual network.

The twin instance mapped to the AnLF 11 of the actual network may perform inference by deploying the sent AI/ML model S445 and providing the signal generated from the digital twin network 30 and forwarded duplicated traffic to the AI/ML model S450.

When simulation starts using the digital twin network 30 in which the AI/ML model is deployed, the VCF 111 may request the MEF 113 to perform reliability evaluation of the AI/ML model S455. At this time, the VCF 111 may send, to the MEF 113, evaluation-related information such as the AI/ML model ID, ID and information of the NF within the twin network in which the AI/ML model is deployed, the performance evaluation metric and the operational stability evaluation metric for reliability evaluation, evaluation period, evaluation duration, and a target endpoint to which to notify of the evaluation result.

In one embodiment, the VCF 111 may request the MEF 113 to perform reliability evaluation of the AI/ML model using Nmef_MLMoldelEvaluation_Subscribe service operation. Table 4 below shows the parameters sent from the VCF 111 to the MEF 113 through the Nmef_MLMoldelEvaluation_Subscribe service operation. The information of Table 4 may be sent from the VCF 111 to the MEF 113 through a different procedure.

TABLE 4

| | Parameters | Description |
|---|---|---|
| I | ML Model ID | ID of AI/ML model which is an evaluation |
| | (Verification | target |
| | Target ML Model) | |
| | NF ID | ID of NF which has requested evaluation |
| | | (e.g., VCF) |
| | Verification | ID of an entity in which AI/ML model is |
| | Target ID | operated (e.g., consumer NF of the AI/ML |
| | | model) |
| | Verification Metrics | Metric to be measured for evaluation |
| | (w/Expected values) | (expected value for each metric if necessary) |
| | Evaluation Duration | Time period during which evaluation is |
| | | performed |
| | Evaluation Period | Evaluation period |
| | Notification End | Target endpoint to which to notify of the |
| | Point | evaluation result |
| O | Operation execution | |
| | result indication | |
| | Subscription | |
| | Correlation ID | |

In one embodiment, the VCF 111 may request evaluation of one or more AI/ML models. The VCF 111 may request evaluation of at least one AI/ML model by sending ML model ID and content for evaluation (verification metrics) to the MEF 113.

The MEF 113 may start evaluation of the AI/ML model by receiving necessary information and using the performance evaluation metric and the operational stability evaluation metric received from the VCF 111 S460. The MEF 113 may collect necessary information from twin instances within the digital twin network 30 through the OAM 21 and/or from the actual network 10 to measure the performance evaluation metric and the operational stability evaluation metric.

Once the information is collected, the MEF 113 may perform analysis of the performance evaluation metric and the operational stability evaluation metric and output the evaluation result S465. When an internal policy is given in advance for the evaluation period and duration, or the entity requesting evaluation specifies the evaluation period and duration, the MEF 113 may perform evaluations periodically throughout the predetermined evaluation duration.

When the reliability evaluation result is generated, the MEF 113 may send the evaluation result to the VCF 111 S470. The VCF 111 may send the sent reliability evaluation result to the MTLF 12 S475, and the MTLF 12 may send the AI/ML model for which the reliability evaluation has been completed and the reliability evaluation result of the corresponding AI/ML model to the AnLF 11 S480.

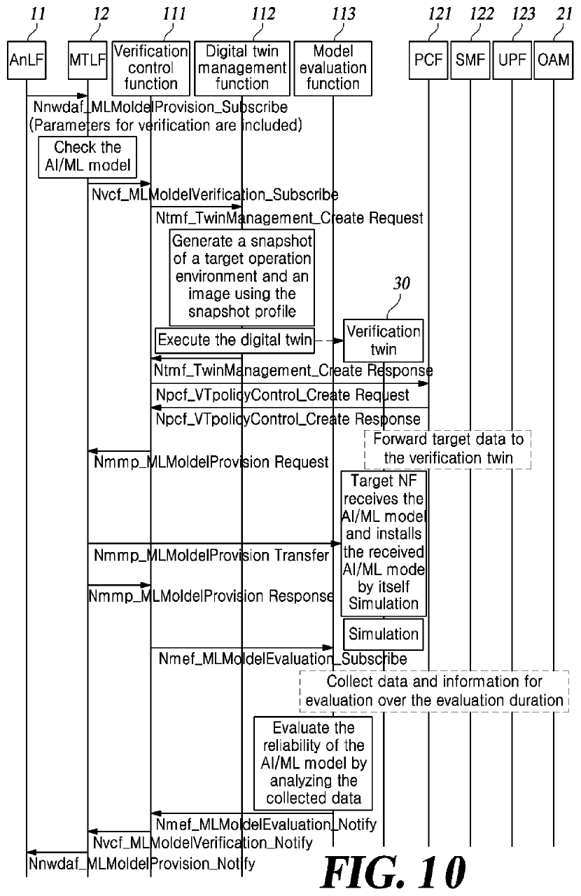

FIG. 10 is a flow diagram illustrating a method for verifying the reliability of an AI/ML model according to yet still another embodiment.

Referring to FIG. 10, the AnLF 11 or the NWDAF including the AnLF 11 may request an AI/ML model from the MTLF 12 or the NWDAF including the MTLF 12 S505. In one embodiment, the AnLF 11 may request an AI/ML model from the MTLF 12 through Nnwdaf_MLMoldelProvision_Subscribe service operation. At this time, the network configuration reference information and evaluation-related parameters for evaluating the AI/ML model may be sent to the MTLF 12. The evaluation-related parameters for evaluating the AI/ML model may include the performance evaluation metric and the operational stability evaluation metric of the AI/ML model, evaluation duration, and evaluation period.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the MAE, MAPE, MSE, and RMSE utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. To evaluate the operational stability of the AI/ML model, operational stability performance metrics, such as availability, security, scalability, and an indicator indicating whether inference time is within an acceptable range may be used.

The MTLF 12 which has received an AI/ML model request from the AnLF 11 or the NWDAF including the AnLF 11 may check the requested AI/ML model S510. The MTLF 12 may check the presence of the requested AI/ML model and create one by training a new AI/ML model in the absence of the requested AI/ML model.

When the presence of the requested AI/ML model is confirmed, the MTLF 12 may request the VCF 111 to evaluate the reliability of the AI/ML model S515. When the MTLF 12 requests the VCF 111 to evaluate the reliability of the AI/ML model, the Nvcf_MLModelVerification_Subscribe service operation may be used. Table 1 shows the information sent from the MTLF 12 to the VCF 111 through the Nvcf_MLModelVerification_Subscribe service operation.

The MTLF 12 may send information on the endpoint to which to send the meta information and evaluation results of the AI/ML model to be evaluated along with a reliability evaluation request. The meta information of the AI/ML model may include an identifier (ID) of the AI/ML model and information on the consumer NF of the AI/ML model. Also, the MTLF 12 may send the network configuration reference information and evaluation-related parameters of the AI/ML model received from the AnLF 11 to the VCF 111.

The VCF 111 may request the DTMF 112 to create a digital twin network for the operation of the AI/ML model S520. When the VCF 111 requests a digital twin network from the DTMF 112, the Ndtmf_TwinManagement_Create service operation may be used. Table 2 shows the information sent from the VCF 111 to the DTMF 112 through the Ndtmf_TwinManagement_Create service operation.

The DTMF 112 may collect data required for the configuration of the twin network based on the network configuration reference information received from the VCF 111 and generate snapshots and images of the actual network based on the collected data S525.

Generating a snapshot of the actual network is a technique used to create a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the DTMF 112 may execute the digital twin network that replicates the actual network by using the snapshot image S530. Each constituting element of the digital twin network 30 may be executed as a twin instance and may be operated with the same configuration as each individual constituting element and in synchronization with the data mapped to the actual network. After executing the digital twin network 30, the DTMF 112 may send Ndtmf_TwinManagement_Create response to the VCF 111.

The VCF 111 may request the PCF 121 to perform generation of a forwarding policy and traffic forwarding so that the traffic of the actual network is duplicated and forwarded to the digital twin network 30 S535. The VCF 111 may request the PCF 121 to perform generation of the forward policy and traffic forwarding by using Npcf_VTPolicyControl_Create service operation. Table 3 shows the information sent from the VCF 111 to the PCF 121 through the Npcf_VTPolicyControl_Create service operation.

When generation of a forwarding policy and traffic forwarding are requested, the VCF 111 may send traffic forwarding reference information, such as the ID of an entity that requests generation of a forwarding policy, the ID and address of a target endpoint to which filtered data are forwarded according to the forwarding policy, and a data filter context identifier, to the PCF 121.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a PDU session ID, S-NSSAI, DNN, RAT type, an internal group identifier, network area information, a MAC address of the target endpoint or IP 3-tuple (destination IP, destination port, protocol) information, packet filters for PDU sessions, related routing profile IDs, or N6 traffic routing information.

The PCF 121 may generate a packet data forwarding policy based on the traffic forwarding reference information received from the VCF 111. The packet data forwarding policy generated by the PCF 121 may be sent to the SMF 122.

The SMF 122 may generate a data forwarding rule such as the PDR and the FAR based on the generated packet data forwarding policy and send the data forwarding rule to the UPF 123. In one embodiment, the PDR may include parameters related to packet duplication, and the FAR may include parameters related to packet duplication instruction. The UPF may identify the mirroring requirements of the SMF 122 from the parameters related to packet duplication within the PDR and/or the parameters related to the packet duplication instruction within the FAR, duplicate filtered packet data, and forward the duplicated packets to the target endpoint.

In one embodiment, the PDR may include information such as the Internet Protocol version 4 (IPv4), Internet Protocol version 6 (IPv6), and IPv4v6-based core network (CN) tunnel information on the PDU session type, network Instance, quality of service (QOS) flow identifier (QFI), IP packet filter set, application identifier, S-NSSAI, a UE identifier, a group of UEs, a random UE, and whether packet data is duplicated. For the Ethernet-based PDU session type, the PDR may include information such as the CN tunnel information, network instance, QFI, Ethernet packet filter set, S-NSSAI, a UE identifier, a group of UEs, a random UE, and whether packet data is duplicated. The FAR may include information such as forwarding operation information, forwarding target information, and whether the packet data is duplicated.

The UPF 123 may filter the packet data to be sent to the digital twin network 30 according to the PDR, duplicate the packet data identified by the filtering, and forward the duplicated packet data to the target endpoint within the digital twin network according to the FAR.

FIG. 5 illustrates a method for duplicating network traffic of the actual network and forwarding the duplicated network traffic to a digital twin network by the PCF 121, SMF 122, and UPF 123.

The VCF 111 may request the MTLF 12 to send the AI/ML model, which is a reliability evaluation target, to a twin instance (NWDAF twin instance including the AnLF) within the digital twin network 30 S540. The twin instance to which the AI/ML model is sent may be a twin instance supposed to use the AI/ML model (NWDAF twin instance including the AnLF) or a twin instance mapped to the AnLF 11 in the actual network.

The VCF 111 may request the MTLF 12 to send the AI/ML model through Nmmp_MLMoldelProvision_Request service operation. In the Nmmp_MLMoldelProvision_Request service operation, ML model provider (mmp) may be the provider of the ML model, and in one embodiment, mmp may be the MTLF 12. Table 5 below shows the parameters sent from the VCF 111 to the MTLF 12 through the Nmmp_MLMoldelProvision_Request service operation. The information shown in Table 5 may be sent from the VCF 111 to the MTLF 12 through a procedure other than the Nmmp_MLMoldelProvision_Request service operation.

TABLE 5

| | Parameters | Description |
|---|---|---|
| I | ML Model ID | ID of AI/ML model to be provided |
| | NF ID | ID of NF (e.g., VCF) which has requested AI/ML |
| | | model |
| | Notification | ID and address of a target endpoint within |
| | Target Address | verification twin to which filtered data is |
| | | supposed to be forwarded according to a policy |
| O | Success or | Response to the request |
| | Failure | |
| | Request | Reference ID for the request |
| | Reference ID | |

The twin instance mapped to the AnLF 11 of the actual network may perform inference by deploying the sent AI/ML model S545 and providing the signal generated from the digital twin network 30 and forwarded duplicated traffic to the AI/ML model S550.

When simulation starts using the digital twin network 30 in which the AI/ML model is deployed, the VCF 111 may request the MEF 113 to perform reliability evaluation of the AI/ML model S555. At this time, the VCF 111 may send, to the MEF 113, evaluation-related information such as the AI/ML model ID, ID and information of the NF within the twin network in which the AI/ML model is deployed, the performance evaluation metric and the operational stability evaluation metric for reliability evaluation, evaluation period, evaluation duration, and a target endpoint to which to notify of the evaluation result.

In one embodiment, the VCF 111 may request the MEF 113 to perform reliability evaluation of the AI/ML model using Nmef_MLMoldelEvaluation_Subscribe service operation. Table 4 below shows the information sent from the VCF 111 to the MEF 113 through the Nmef_MLMoldelEvaluation_Subscribe service operation. The information of Table 4 may be sent from the VCF 111 to the MEF 113 through a procedure other than the Nmef_MLMoldelEvaluation_Subscribe service operation.

The MEF 113 may start evaluation of the AI/ML model by receiving necessary information and using the performance evaluation metric and the operational stability evaluation metric received from the VCF 111 S560. The MEF 113 may collect necessary information from twin instances within the digital twin network 30 through the OAM 21 and/or from the actual network to measure the performance evaluation metric and the operational stability evaluation metric.

Once the information is collected, the MEF 113 may perform analysis of the performance evaluation metric and the operational stability evaluation metric and output the evaluation result S565. When an internal policy is given in advance for the evaluation period and duration, or the entity requesting evaluation specifies the evaluation period and duration, the MEF 113 may perform evaluations periodically throughout the predetermined evaluation duration.

When the reliability evaluation result is generated, the MEF 113 may send the evaluation result to the VCF 111 S570. The VCF 111 may send the sent reliability evaluation result to the MTLF 12 S575, and the MTLF 12 may send the AI/ML model for which the reliability evaluation has been completed and the reliability evaluation result of the corresponding AI/ML model to the AnLF 11 S580.

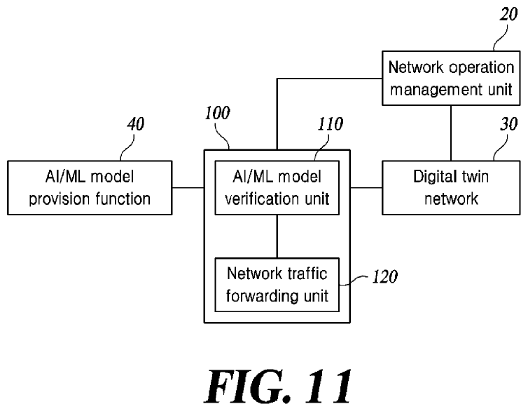

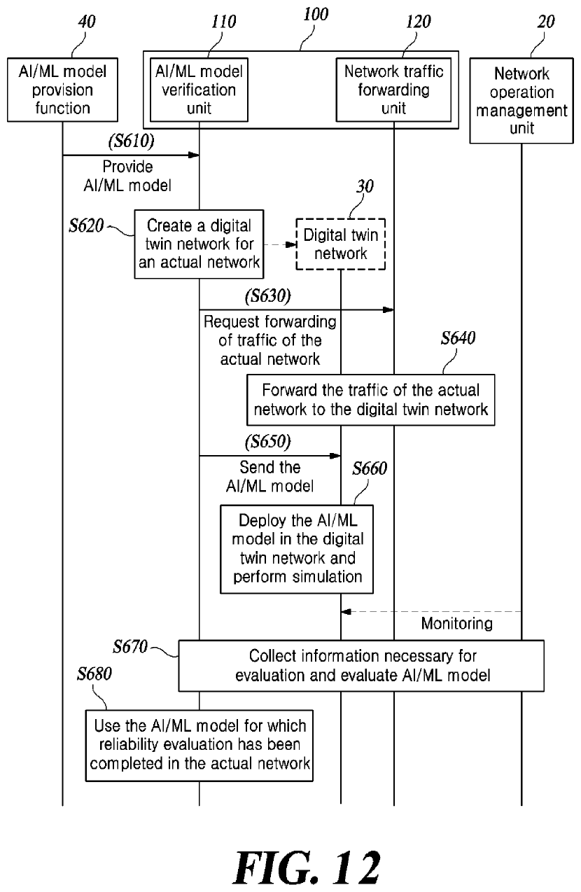

FIG. 11 shows a block diagram of a system for verifying the reliability of an AI/ML model according to yet still another embodiment, and FIG. 12 is a flow diagram illustrating a method for verifying the reliability of an AI/ML model according to still yet another embodiment.

Referring to FIG. 11, the system for verifying the reliability of an AI/ML model according to yet still another embodiment may include an AI/ML model provision function 40 that provides an AI/ML model, a reliability verification apparatus 100 for performing verification of the AI/ML model and using the AI/ML model, and a network operation management unit 20. The apparatus 100 for verifying the reliability of an AI/ML model may include an AI/ML model verification unit 110 and a network traffic forwarding unit 120.

The apparatus 100 for verifying the reliability of an AI/ML model may be operated in the actual network environment and may verify the reliability of an AI/ML model provided by the AI/ML model provision function 40.

The AI/ML model provision function 40 may develop, learn, and train an AI/ML model and provide the AI/ML model to the consumer of the AI/ML model. In yet still another embodiment, the consumer of the AI/ML model may be the reliability verification apparatus 100.

The AI/ML model verification unit 110 of the reliability verification apparatus 100 may evaluate the reliability of the AI/ML model provided from the AI/ML model provision function 40 by evaluating the AI/ML model according to a performance evaluation metric or an operational stability evaluation metric. The reliability verification apparatus 100 according to yet still another embodiment may determine whether to use the AI/ML model based on the reliability verification result and perform inference using the AI/ML model.

To verify the reliability of the AI/ML model, the network traffic forwarding unit 120 duplicates the entire or a portion of the network traffic from the actual network environment in which the AI/ML model is to be deployed and operated; and forwards the duplicated network traffic to the digital twin network 30 that replicates the whole or part of the actual network environment.

The network operation management unit 20 may monitor the actual network environment and the environment of the digital twin network 30.

The digital twin network 30 is intended to verify the reliability of an AI/ML model, which is a network that replicates the whole or part of the actual network environment in which the AI/ML model is deployed and operated.

Referring to FIG. 12, the AI/ML model provision function 40 may provide an AI/ML model to the AI/ML model verification unit 110 S610. The AI/ML model provision function 40 may send the location information of the AI/ML model to the reliability verification apparatus 100 so that the reliability verification apparatus 100 downloads the AI/ML model from storage corresponding to the location information. The AI/ML model provision function 40 may send the pre-conducted reliability evaluation result for the AI/ML model to the AI/ML model verification unit 110 together with the AI/ML model itself.

In yet still another embodiment, the AI/ML model provision function 40 may send the network configuration reference information to the reliability verification apparatus 110 together with the AI/ML model. Also, the AI/ML model provision function 40 may send the parameters for evaluating the reliability of the AI/ML model to the reliability verification apparatus 100. The parameters for evaluating the reliability of the AI/ML model may include a performance evaluation metric and an operational stability evaluation metric of the AI/ML model, an evaluation duration, and/or an evaluation period.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the Mean Absolute Error (MAE), Mean Absolute Percentage Error (MAPE), Mean Squared Error (MSE), and Root Mean Squared Error (RMSE) utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. In one embodiment, the performance metric of the operational stability of the AI/ML model may include indicators such as availability, security, scalability, and whether inference time is within an acceptable range.

The AI/ML model verification unit 110 may create a twin network that replicates the actual network based on the network configuration reference information received from the AI/ML model provision function 40 S620.

The AI/ML model verification unit 110 may collect data required for the configuration of the twin network and generate snapshots and images of the actual network based on the collected data. Generating a snapshot of the actual network is a technique used to generate a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the AI/ML model verification unit 110 may execute the digital twin network 30 that replicates the actual network by using the snapshot and image of the actual network. Each constituting element of the digital twin network 30 may be executed as a twin instance, and the digital twin network 30 may be operated in synchronization with the actual network using the same configurations and data applied to the individual constituting elements of the actual network.

The AI/ML model verification unit 110 may request the network traffic forwarding unit 120 to perform generation of a forwarding policy and traffic forwarding for mirroring the traffic of the actual network (duplication of the actual network traffic and forwarding of the duplicated traffic to the digital twin network 30) S630.

The AI/ML model verification unit 110 may send the traffic forwarding reference information to the network traffic forwarding unit 120 when requesting the generation of the forwarding policy and traffic forwarding. The traffic forwarding reference information may include the identifier of an entity (e.g., the AI/ML model verification unit 110) requesting the generation of the forwarding policy, the identifier of a target endpoint to which filtered data is forwarded according to the forwarding policy and the address of the target endpoint (which is included within the digital twin network 30), and a data filter context identifier.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a protocol data unit (PDU) session ID, single-network slice selection assistance information (S-NSSAI), data network name (DNN), radio access technology (RAT) type, an internal group identifier, network area information, a media access control (MAC) address of the target endpoint or IP 3-tuple (destination IP, destination port, protocol) information, packet filters for PDU sessions, related routing profile IDs, or N6 traffic routing information.

When the network traffic forwarding unit 120 generate a packet data forwarding policy based on the traffic forwarding reference information received from the AI/ML model verification unit 110 and sends the generated packet data forwarding policy to the user plane function (UPF), the UPF may forward the traffic of the actual network to the digital twin network based on the packet data forwarding policy S640.

The network traffic forwarding unit 120 may generate a data forwarding rule such as the packet detection rule (PDR) and the forwarding action rule (FAR) based on the generated packet data forwarding policy and send the data forwarding rule to the UPF. The UPF may filter the packet data to be sent to the digital twin network 30 according to the PDR, duplicate the packet data identified by the filtering, and forward the duplicated packet data to the target endpoint within the digital twin network according to the FAR.

In one embodiment, the PDR may include parameters related to packet duplication, and the FAR may include parameters related to packet duplication instruction. The UPF may identify the mirroring requirements of the network traffic forwarding unit 120 from the parameters related to packet duplication within the PDR and/or the parameters related to the packet duplication instruction within the FAR, duplicate filtered packet data, and forward the duplicated packets to the target endpoint.

The AI/ML model verification unit 110 may send the AI/ML model, which is a reliability evaluation target, to the digital twin network 30 S650. In one embodiment, the AI/ML model verification unit 110 may send the AI/ML model to a target twin instance supposed to use the AI/ML model among twin instances in the digital twin network. The target twin instance may be a twin instance mapped to the AI/ML model provision function 40 in the actual network.

The digital twin network 30 may deploy the AI/ML model and perform simulation using the traffic forwarded from the actual network S660. In other words, the target twin instance may perform inference by deploying the sent AI/ML model and providing the signal generated from the digital twin network 30 and forwarded duplicated traffic to the AI/ML model.

When the digital twin network 30 in which the AI/ML model has been deployed starts simulation using the AI/ML model, the AI/ML model verification unit 110 may evaluate the AI/ML model based on the performance evaluation metric and the operational stability evaluation metric received from the AI/ML model provision function 40 S670. In yet still another embodiment, the AI/ML model verification unit 110 may evaluate the AI/ML model by considering the reliability evaluation result generated by the AI/ML model provision function 40 together with the performance evaluation metric and the operational stability evaluation metric.

The AI/ML model verification unit 110 may collect necessary information from twin instances within the digital twin network 30 through the network operation management unit 20 and/or from the actual network to measure the performance evaluation metric and the operational stability evaluation metric.

Once the information is collected, the AI/ML model verification unit 110 may evaluate the AI/ML model using the performance evaluation metric and the operational stability evaluation metric and generate an evaluation result. When an internal policy is given in advance for the evaluation period and duration, or the entity requesting evaluation specifies the evaluation period and duration, the AI/ML model verification unit 110 may perform evaluations periodically throughout the specified evaluation duration.

When the reliability evaluation result is generated, the AI/ML model verification unit 110 may determine whether to use the AI/ML model based on the AI/ML model and the evaluation result of the corresponding AI/ML model and may use, in the actual network, the AI/ML model for which the reliability evaluation has been completed S680.

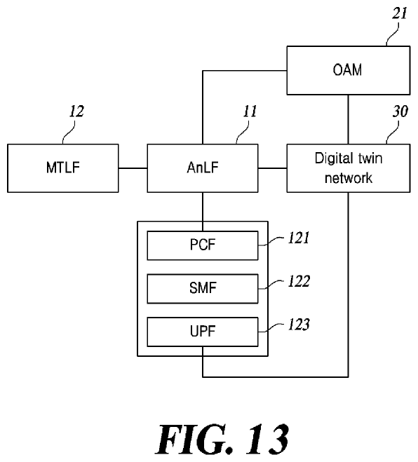

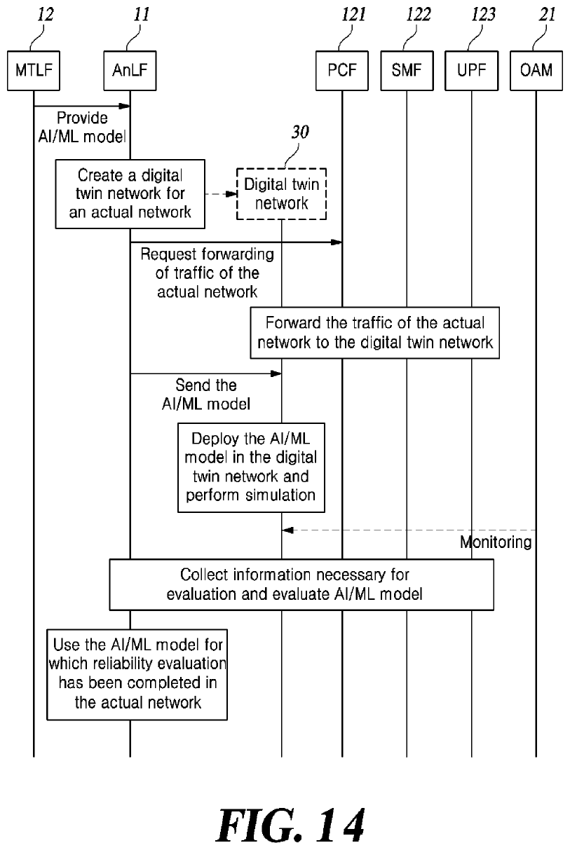

FIG. 13 shows a block diagram of a system for verifying the reliability of an AI/ML model according to still yet another embodiment, and FIG. 14 is a flow diagram illustrating a method for verifying the reliability of an AI/ML model according to yet further another embodiment.

Referring to FIG. 13, a system for verifying the reliability of an AI/ML model according to still yet another embodiment may include AnLF 11 which uses an AI/ML model for which verification has been performed and whose reliability has been verified, MTLF 12 which provides an AI/ML model to be verified and used by the AnLF 11, and OAM 21.

The AnLF 11 is operated in the actual network environment; the AnLF 11 may verify the reliability of the AI/ML model provided by the MTLF 12 and use the AI/ML model whose reliability has been verified. The AnLF 11 may verify the reliability of the AI/ML model by evaluating the AI/ML model according to the performance evaluation metric and the operational stability evaluation metric. The AnLF 11 of FIG. 13 may be included within the NWDAF and correspond to the AI/ML model verification unit 110 of FIG. 11.

The MTLF 12 may create an AI/ML model and perform learning and training on the created AI/ML model. The MTLF 12 may be included in the NWDAF. Also, the MTLF 12 may provide the AI/ML model and the reliability evaluation result of the corresponding AI/ML model to the AnLF 11 or the NWDAF including the AnLF 11. The reliability evaluation of the AI/ML model may be pre-conducted individually by the MTLF 12.

The digital twin network 30 may be created by the AnLF 11 to verify the reliability of the AI/ML model, which may be a replication of the entire or a portion of the actual network environment in which the AI/ML model is deployed and operated.

Network traffic forwarding of the reliability verification system shown in FIG. 13 may be performed by the policy control function (PCF) 121, the session management function (SMF) 122, and the UPF 123. In other words, the PCF 121, SMF 122, and UPF 123 of FIG. 13 may duplicate network traffic from the actual network environment, forward (i.e., mirror) the duplicated network traffic to the digital twin network 30, and perform the same function as the network traffic forwarding unit 120 of FIG. 11.

The PCF 121 may generate a policy for duplicating the entire or a portion of the network traffic of the actual network environment (a portion of the network traffic may be selected according to a predetermined policy) and forwarding the duplicated traffic to the digital twin network 30.

The SMF 122 may generate at least one rule to be applied to the UPF 123 according to the policy generated by the PCF 121 and send the generated rule to the UPF 123.

The UPF 123 may detect packet data according to the rule sent from the SMF 122, duplicate the detected packet data, and forward the duplicated packet data to the digital twin network 30.

The OAM 21 may monitor the actual network and the digital twin network 30.

FIG. 14 illustrates a method for verifying the reliability of an AI/ML model by the AnLF 11 according to one embodiment.

Referring to FIG. 14, the MTLF 12 may provide an AI/ML model to the AnLF 11 S710. The MTLF 12 may send the location information of the AI/ML model to the AnLF 11 so that the AnLF 11 downloads the AI/ML model from storage corresponding to the location information. Here, the AnLF 11 and the MTLF 12 may be included in the different NWDAFs. The MTLF 12 may send the pre-conducted reliability evaluation result for the AI/ML model to the AnLF 11 together with the AI/ML model itself.

The MTLF 12 may send the network configuration reference information to the AnLF 11 or the NWDAF including the AnLF 11. The MTLF 12 may send evaluation-related parameters for evaluating an AI/ML model, such as the performance evaluation metric and the operational stability evaluation metric of the AI/ML model, evaluation duration, and evaluation period, to the AnLF 11 or the NWDAF including the AnLF 11.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the MAE, MAPE, MSE, and RMSE utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. To evaluate the operational stability of the AI/ML model, operational stability performance metrics, such as availability, security, scalability, and an indicator indicating whether inference time is within an acceptable range may be used.

The AnLF 11 may create a twin network that replicates the actual network based on the network configuration reference information received from the MTLF 12 S720.

To create a digital twin network, the AnLF 11 may collect data required for the configuration of the twin network and generate snapshots and images of the actual network based on the collected data. Generating a snapshot of the actual network is a technique used to create a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the AnLF 11 may execute the digital twin network that replicates the actual network by using the snapshot and image of the actual network. Each constituting element of the digital twin network 30 may be executed as a twin instance, and the digital twin network 30 may be operated in synchronization with the actual network using the same configurations and data applied to the individual constituting elements of the actual network.

The AnLF 11 may request the PCF 121 to perform generation of a forwarding policy and traffic forwarding for mirroring the traffic of the actual network (duplication of the actual network traffic and forwarding of the duplicated traffic to the digital twin network 30) S730.

Afterward, the PCF 121, SMF 122, and UPF 123 may forward the traffic of the actual network to the digital twin network according to the request of the AnLF 11 S740. FIG. 5 illustrates a method for replicating network traffic of an actual network by the PCF 121, SMF 122, and UPF 123 and forwarding the duplicated network traffic to a digital twin network.

The AnLF 11 may send the traffic forwarding reference information to the PCF 121 when requesting the generation of the forwarding policy and traffic forwarding. The traffic forwarding reference information may include the identifier of an entity (e.g., the NWDAF including the AnLF 11) requesting the generation of the forwarding policy, the identifier of a target endpoint to which filtered data is forwarded according to the forwarding policy and the address of the target endpoint (which is included within the digital twin network 30), and a data filter context identifier.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a PDU session ID, S-NSSAI, DNN, RAT type, an internal group identifier, network area information, a MAC address of the target endpoint or IP 3-tuple (destination IP, destination port, protocol) information, packet filters for PDU sessions, related routing profile IDs, or N6 traffic routing information.

The PCF 121 may generate a packet data forwarding policy based on the traffic forwarding reference information received from the AnLF 11. The PCF 121 may send the generated packet data forwarding policy to the SMF 122.

The SMF 122 may generate a data forwarding rule such as the PDR and the FAR based on the generated packet data forwarding policy and send the data forwarding rule to the UPF 123.

In one embodiment, the PDR may include parameters related to packet duplication, and the FAR may include parameters related to packet duplication instruction. The UPF may identify the mirroring requirements of the SMF 122 from the parameters related to packet duplication within the PDR and/or the parameters related to the packet duplication instruction within the FAR, duplicate filtered packet data, and forward the duplicated packets to the target endpoint.

In one embodiment, the PDR may include information such as the Internet Protocol version 4 (IPv4), Internet Protocol version 6 (IPv6), and IPv4v6-based core network (CN) tunnel information on the PDU session type, network Instance, quality of service (QOS) flow identifier (QFI), IP packet filter set, application identifier, S-NSSAI, a UE identifier, a group of UEs, a random UE, and whether packet data is duplicated. For the Ethernet-based PDU session type, the PDR may include information such as the CN tunnel information, network instance, QFI, Ethernet packet filter set, S-NSSAI, a UE identifier, a group of UEs, a random UE, and whether packet data is duplicated. The FAR may include information such as forwarding operation information, forwarding target information, and whether the packet data is duplicated.

The UPF 123 may filter the packet data to be sent to the digital twin network 30 according to the PDR, duplicate the packet data identified by the filtering, and forward the duplicated packet data to the target endpoint within the digital twin network according to the FAR.

The AnLF 11 may send the AI/ML model, which is a reliability evaluation target, to the digital twin network 30 S750. In one embodiment, the AnLF 11 may send the AI/ML model to a target twin instance (the twin instance of NWDAF in which the AnLF 11 is included) supposed to use the AI/ML model among twin instances in the digital twin network. The target twin instance may be a twin instance mapped to the AnLF 11 in the actual network.

The twin instance of NWDAF in which the AnLF 11 is included may deploy the AI/ML model and perform simulation using the traffic forwarded from the actual network S760. In other words, the target twin instance may perform inference by deploying the sent AI/ML model and providing the signal generated from the digital twin network 30 and forwarded duplicated traffic to the AI/ML model.

When the digital twin network 30 in which the AI/ML model has been deployed starts simulation using the AI/ML model, the AnLF 11 may evaluate the AI/ML model based on the reliability evaluation pre-conducted by the MTLF 12 S770. The AnLF 11 may consider both the performance evaluation metric and the operational stability evaluation metric for the evaluation of the AI/ML model. The AnLF 11 may collect necessary information from twin instances within the digital twin network 30 through the OAM 21 and/or from the actual network to measure the performance evaluation metric and the operational stability evaluation metric.

Once the information is collected, the AnLF 11 may evaluate the AI/ML model using the performance evaluation metric and the operational stability evaluation metric and generate an evaluation result. When an internal policy is given in advance for the evaluation period and duration, or the entity requesting evaluation specifies the evaluation period and duration, the AnLF 11 may perform evaluations periodically throughout the specified evaluation duration.

When a reliability evaluation result is generated, the AnLF 11 may determine whether to use the AI/ML model based on the AI/ML model and the evaluation result of the corresponding AI/ML model. The AnLF 11 may use the AI/ML model which has satisfied the reliability evaluation criterion in the actual network S780.

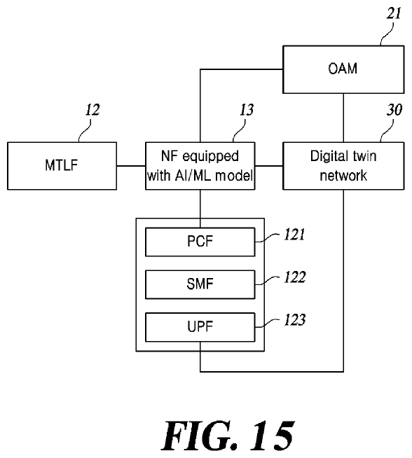

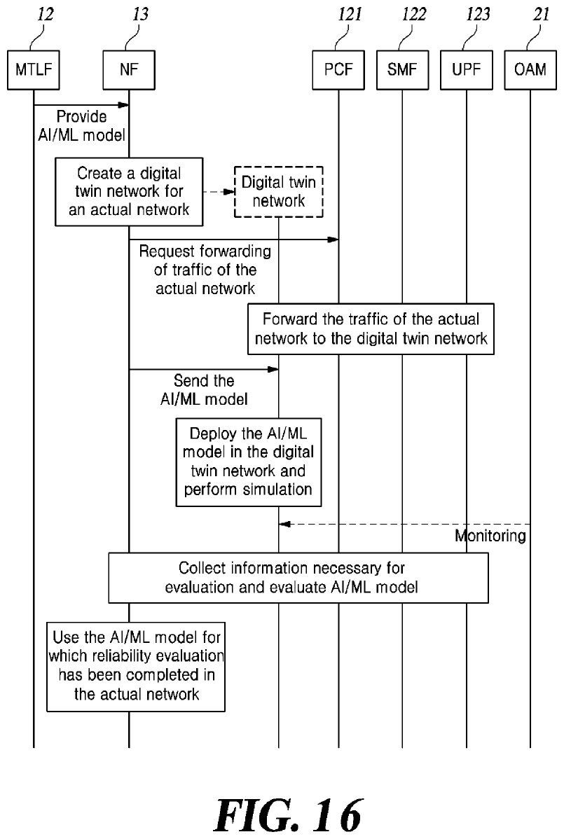

FIG. 15 shows a block diagram of a system for verifying the reliability of an AI/ML model according to yet further another embodiment, and FIG. 16 is a flow diagram illustrating a method for verifying the reliability of an AI/ML model according to still further another embodiment.

Referring to FIG. 15, a system for verifying the reliability of an AI/ML model according to yet further another embodiment may include NF 13 which evaluates the reliability of an AI/ML model and uses an AI/ML model for which reliability verification has been completed, MTLF 12 which provides an AI/ML model to the NF 13, and OAM 12.

In FIG. 15, the MTLF 12 or the NWDAF in which the MTLF 12 is included may develop, learn, and train an AI/ML model and provide the AI/ML model to the NF 13. The MTLF 12 may send the location information of the AI/ML model to the NF 13 so that the NF 13 downloads the AI/ML model from storage corresponding to the location information.

The MTLF 12 may provide the AI/ML model and the reliability evaluation result of the corresponding AI/ML model to the NF 13. The reliability evaluation of the AI/ML model may be pre-conducted individually by the MTLF 12.

The AI/ML model may be embedded in the NF 13. The NF 13 may be operated in the actual network environment; the reliability of the AI/ML model may be evaluated by the MTLF 12, and the reliability of the AI/ML model may be evaluated according to the performance evaluation metric and the operational stability evaluation metric. The NF 13 may perform inference by using the AI/ML model which has satisfied the reliability verification criterion.

In the reliability verification system of FIG. 15, network traffic forwarding may be performed by the PCF 121, the SMF 122, and the UPF 123. In other words, the PCF 121, SMF 122, and UPF 123 of FIG. 15 may duplicate network traffic from the actual network environment, forward (i.e., mirror) the duplicated network traffic to the digital twin network 30, and perform the same function as the network traffic forwarding unit 120 of FIG. 11.

The PCF 121 may generate a policy for duplicating the entire or a portion of the network traffic of the actual network environment (a portion of the network traffic may be selected according to a predetermined policy) and forwarding the duplicated traffic to the digital twin network 30.

The SMF 122 may generate at least one rule to be applied to the UPF 123 according to the policy generated by the PCF 121 and send the generated rule to the UPF 123.

The UPF 123 may detect packet data according to the rule sent from the SMF 122, duplicate the detected packet data, and forward the duplicated packet data to the digital twin network 30.

The OAM 21 may monitor the actual network and the digital twin network 30.

FIG. 16 illustrates a method for verifying the reliability of an AI/ML model by the NF 13 according to yet further another embodiment.

Referring to FIG. 16, the MTLF 12 may provide an AI/ML model to the NF 13 S810. The MTLF 12 may send the location information of the AI/ML model to the NF 13 so that the NF 13 downloads the AI/ML model from storage corresponding to the location information. The MTLF 12 may send the pre-conducted reliability evaluation result for the AI/ML model to the NF 13 together with the AI/ML model itself.

The MTLF 12 may also send the network configuration reference information to the NF 13 while providing the AI/ML model. Also, the MTLF 12 may send evaluation-related parameters for evaluating an AI/ML model, such as the performance evaluation metric and the operational stability evaluation metric of the AI/ML model, evaluation duration, and evaluation period, to the NF 13.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the MAE, MAPE, MSE, and RMSE utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. To evaluate the operational stability of the AI/ML model, operational stability performance metrics, such as availability, security, scalability, and an indicator indicating whether inference time is within an acceptable range may be used.

The NF 13 may create a twin network that replicates the actual network based on the network configuration reference information received from the MTLF 12 S820.

The NF 13 may collect data required for the configuration of the twin network and generate snapshots and images of the actual network based on the collected data. Generating a snapshot of the actual network is a technique used to create a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the NF 13 may execute the digital twin network 30 that replicates the actual network by using the snapshot and image of the actual network. Each constituting element of the digital twin network 30 may be executed as a twin instance, and the digital twin network 30 may be operated in synchronization with the actual network using the same configurations and data applied to the individual constituting elements of the actual network.

The NF 13 may request the PCF 121 to perform generation of a forwarding policy and traffic forwarding for mirroring the traffic of the actual network (duplication of the actual network traffic and forwarding of the duplicated traffic to the digital twin network 30) S830.

Afterward, the PCF 121, SMF 122, and UPF 123 may forward the traffic of the actual network to the digital twin network according to the request of the NF 13 S840. FIG. 5 illustrates a method for replicating network traffic of an actual network by the PCF 121, SMF 122, and UPF 123 and forwarding the duplicated network traffic to a digital twin network.

The NF 13 may send the traffic forwarding reference information to the PCF 121 when requesting the generation of the forwarding policy and traffic forwarding. The traffic forwarding reference information may include the identifier of an entity (e.g., the NF 13) requesting the generation of the forwarding policy, the identifier of a target endpoint to which filtered data is forwarded according to the forwarding policy and the address of the target endpoint (which is included within the digital twin network 30), and a data filter context identifier.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a PDU session ID, S-NSSAI, DNN, RAT type, an internal group identifier, network area information, a MAC address of the target endpoint or IP 3-tuple (destination IP, destination port, protocol) information, packet filters for PDU sessions, related routing profile IDs, or N6

The PCF 121 may generate a packet data forwarding policy based on the traffic forwarding reference information received from the NF 13. The PCF 121 may send the generated packet data forwarding policy to the SMF 122.

The SMF 122 may generate a data forwarding rule such as the PDR and the FAR based on the generated packet data forwarding policy and send the data forwarding rule to the UPF 123.

In one embodiment, the PDR may include parameters related to packet duplication, and the FAR may include parameters related to packet duplication instruction. The UPF may identify the mirroring requirements of the SMF 122 from the parameters related to packet duplication within the PDR and/or the parameters related to the packet duplication instruction within the FAR, duplicate filtered packet data, and forward the duplicated packets to the target endpoint.

In one embodiment, the PDR may include information such as the Internet Protocol version 4 (IPv4), Internet Protocol version 6 (IPv6), and IPv4v6-based core network (CN) tunnel information on the PDU session type, network Instance, quality of service (QOS) flow identifier (QFI), IP packet filter set, application identifier, S-NSSAI, a UE identifier, a group of UEs, a random UE, and whether packet data is duplicated. For the Ethernet-based PDU session type, the PDR may include information such as the CN tunnel information, network instance, QFI, Ethernet packet filter set, S-NSSAI, a UE identifier, a group of UEs, a random UE, and whether packet data is duplicated. The FAR may include information such as forwarding operation information, forwarding target information, and whether the packet data is duplicated.

The UPF 123 may filter the packet data to be sent to the digital twin network 30 according to the PDR, duplicate the packet data identified by the filtering, and forward the duplicated packet data to the target endpoint within the digital twin network according to the FAR.

The NF 13 may send the AI/ML model, which is a reliability evaluation target, to the digital twin network 30 S850. In yet further another embodiment, the NF 13 may send the AI/ML model to a target twin instance (the twin instance in which the NF 13 is included) supposed to use the AI/ML model among twin instances in the digital twin network. The target twin instance may be a twin instance mapped to the NF 13 in the actual network.

The twin instance in which the NF 13 is included may deploy the AI/ML model and perform simulation using the traffic forwarded from the actual network S860. In other words, the target twin instance may perform inference by deploying the sent AI/ML model and providing the signal generated from the digital twin network 30 and forwarded duplicated traffic to the AI/ML model.

When the digital twin network 30 in which the AI/ML model has been deployed starts simulation using the AI/ML model, the NF 13 may evaluate the AI/ML model based on the reliability evaluation result received from the MTLF 12 and the performance evaluation metric and the operational stability evaluation metric S870. The NF 13 may collect necessary information from twin instances within the digital twin network 30 through the OAM 21 and/or from the actual network to measure the performance evaluation metric and the operational stability performance metric.

Once the information is collected, the NF 13 may evaluate the AI/ML model using the performance evaluation metric and the operational stability evaluation metric and generate an evaluation result. When an internal policy is given in advance for the evaluation period and duration, or the entity requesting evaluation specifies the evaluation period and duration, the NF 13 may perform evaluations periodically throughout the specified evaluation duration.

When a reliability evaluation result is generated, the NF 13 may determine whether to use the AI/ML model based on the AI/ML model and the evaluation result of the corresponding AI/ML model. The NF 13 may use the AI/ML model which has satisfied the reliability evaluation criterion in the actual network S880.

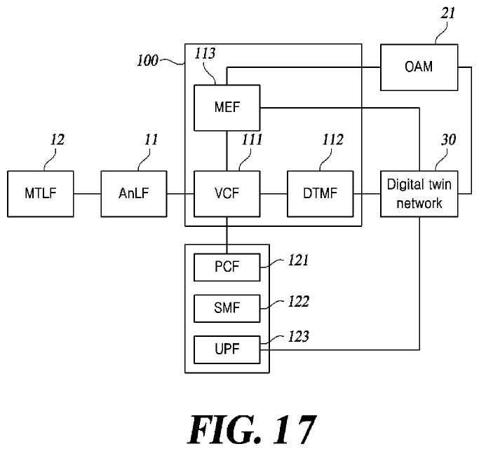

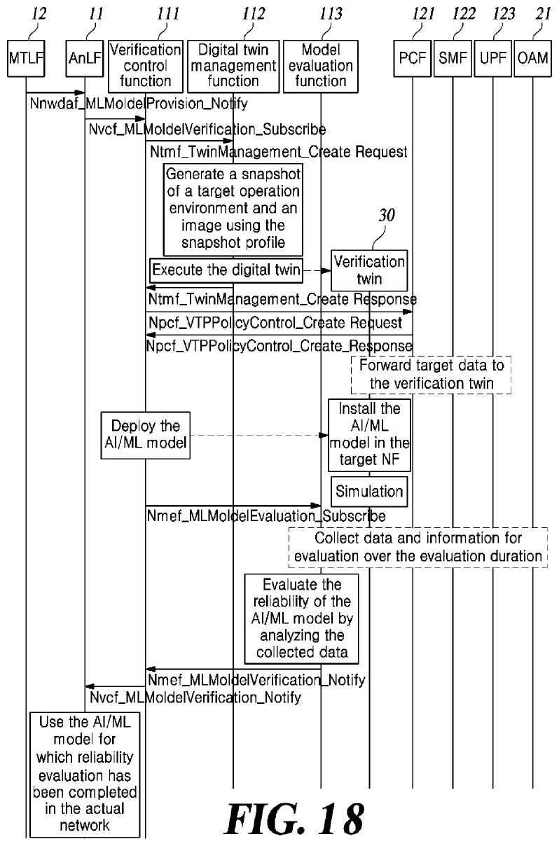

FIG. 17 shows a block diagram of a system for verifying the reliability of an AI/ML model according to still further another embodiment, and FIG. 18 is a flow diagram illustrating a method for verifying the reliability of an AI/ML model according to yet still further another embodiment.

Referring to FIG. 17, a system for verifying the reliability of an AI/ML model according to still further another embodiment may include AnLF 11 which consumes the AI/ML model, MTLF 12 which provides the AI/ML model to be used in the AnLF 11, a reliability verification apparatus 100, and OAM 21.

The AnLF 11 is operated in the actual network environment; the AnLF 11 may deploy and use an AI/ML model according to the reliability verification result of the AI/ML model. The AnLF 11 may perform inference or provide an analysis result using the AI/ML model. The AI/ML model may be embedded in the AnLF 11. The AnLF 11 of FIG. 17 may be included in the NWDAF and correspond to the AI/ML model consumption function 10 of FIG. 11.

The MTLF 12 may create an AI/ML model and perform learning and training on the created AI/ML model. The MTLF 12 may provide an AI/ML model to the AnLF 11 and provide the reliability verification result of the AI/ML model obtained by performing the reliability verification by itself to the AnLF 11. The MTLF 12 may be included in the NWDAF, and the NWDAF including the MTLF 12 may be the same as or different from the NWDAF including the AnLF 11.

The verification control function (VCF) 111 of the reliability verification apparatus 100 may receive a request for reliability evaluation of the AI/ML model from the AnLF 11 or from the NWDAF including the AnLF 11 and control a series of reliability evaluation procedures for the AI/ML model. The VCF 111 may request the digital twin management function (DTMF) 112 to create a digital twin network of the actual network to evaluate the reliability of the AI/ML model. When receiving a response from the DTMF 112, the VCF 111 may request the PCF 121 to perform forwarding of network traffic. When mirrored network traffic is forwarded to the digital twin network, the VCF 111 may request the model evaluation function MEF 113 to evaluate the reliability of the AI/ML model deployed in the digital twin network.

When a digital twin network 30 is requested from the VCF 111, the DTMF 112 may generate the digital twin network 30 for the actual network. The digital twin network 30 may replicate the entire or a portion of the actual network environment in which the AI/ML model is deployed and operated.

When the VCF 111 requests reliability evaluation of the AI/ML model deployed in the digital twin network, the MEF 113 may evaluate the reliability of the AI/ML model deployed in the digital twin network.

Network traffic forwarding of the reliability verification system shown in FIG. 17 may be performed by the PCF 121, the SMF 122, and the UPF 123. In other words, the PCF 121, SMF 122, and UPF 123 of FIG. 17 may duplicate network traffic from the actual network environment, forward (i.e., mirror) the duplicated network traffic to the digital twin network 30, and perform the same function as the network traffic forwarding unit 120 of FIG. 11.

The PCF 121 may generate a policy for duplicating the entire or a portion of the network traffic of the actual network environment (a portion of the network traffic may be selected according to a predetermined policy) and forwarding the duplicated traffic to the digital twin network 30.

The SMF 122 may generate at least one rule to be applied to the UPF 123 according to the policy generated by the PCF 121 and send the generated rule to the UPF 123.

The UPF 123 may detect packet data according to the rule sent from the SMF 122, duplicate the detected packet data, and forward the duplicated packet data to the digital twin network 30.

The OAM 21 may monitor the actual network and the digital twin network 30.

In still further another embodiment, the reliability verification apparatus 100 may be a network function located in a network. When the reliability verification apparatus 100 operates as a reliability verification function in the network, the VCF 111, DTMF 112, and MEF 113 in the reliability verification apparatus 100 may operate as modules in the reliability verification function, and the operations of the VCF 111, DTMF 112, and MEF 113 may be implemented by at least one processor.

FIG. 18 illustrates a method for verifying the reliability of an AI/ML model by the reliability verification apparatus 100 according to still further another embodiment.

Referring to FIG. 18, the AnLF 11 or the NWDAF including the AnLF 11 may receive an AI/ML model from the MTLF 12 or the NWDAF including the MTLF 12 S905. In still further another embodiment, the AnLF 11 may receive an AI/ML model from the MTLF 12 through Nnwdaf_MLMoldelProvision_Subscribe service operation. The MTLF 12 may send the reliability evaluation result of the AI/ML model obtained by itself to the AnLF 11.

The AnLF 11 or the NWDAF including the AnLF 11 may request the VCF 111 to evaluate the reliability of the AI/ML model S910.

At this time, the network configuration reference information and evaluation-related parameters for evaluating the AI/ML model may be sent to the VCF 111. The evaluation-related parameters for evaluating the AI/ML model may include the performance evaluation metric and the operational stability evaluation metric of the AI/ML model, evaluation duration, and evaluation period.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the MAE, MAPE, MSE, and RMSE utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. To evaluate the operational stability of the AI/ML model, operational stability performance metrics, such as availability, security, scalability, and an indicator indicating whether inference time is within an acceptable range may be used.

When the AnLF 11 requests the VCF 111 to evaluate the reliability of the AI/ML model, the Nvcf_MLModelVerification_Subscribe service operation may be used. Table 1 shows the information sent to the VCF 111 through the Nvcf_MLModelVerification_Subscribe service operation.

The AnLF 11 may send information on the endpoint to which to send the meta information and evaluation results of the AI/ML model to be evaluated along with a reliability evaluation request. The meta information of the AI/ML model may include an identifier (ID) of the AI/ML model, the AI/ML model or the location where the AI/ML model is stored (e.g., URL), and information on the consumer NF of the AI/ML model. Also, the AnLF 11 may send the network configuration reference information and evaluation-related parameters of the AI/ML model received from the MTLF 12 to the VCF 111.

The VCF 111 may request the DTMF 112 to create a digital twin network for the operation of the AI/ML model S915. When the VCF 111 requests a digital twin network from the DTMF 112, the Ndtmf_TwinManagement_Create service operation may be used. Table 2 shows the information sent to the DTMF 112 through the Ndtmf_TwinManagement_Create service operation.

The DTMF 112 may collect data required for the configuration of the twin network based on the network configuration reference information received from the VCF 111 and generate snapshots and images of the actual network based on the collected data S920.

Generating a snapshot of the actual network is a technique used to create a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the DTMF 112 may execute the digital twin network that replicates the actual network by using the snapshot image S925. Each constituting element of the digital twin network 30 may be executed as a twin instance and may be operated with the same configuration as each individual constituting element and in synchronization with the data mapped to the actual network. After executing the digital twin network 30, the DTMF 112 may send Ndtmf_TwinManagement_Create response to the VCF 111.

The VCF 111 may request the PCF 121 to perform generation of a forwarding policy and traffic forwarding so that the traffic of the actual network is duplicated and forwarded to the digital twin network 30 S930. The VCF 111 may request the PCF 121 to perform generation of the forward policy and traffic forwarding by using Npcf_VTPolicyControl_Create service operation. Table 3 shows the information sent from the VCF 111 to the PCF 121 through the Npcf_VTPolicyControl_Create service operation.

When generation of a forwarding policy and traffic forwarding are requested, the VCF 111 may send traffic forwarding reference information, such as the ID of an entity that requests generation of a forwarding policy, the ID and address of a target endpoint to which filtered data are forwarded according to the forwarding policy, and a data filter context identifier, to the PCF 121.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a PDU session ID, S-NSSAI, DNN, RAT type, an internal group identifier, network area information, a MAC address of the target endpoint or IP 3-tuple (destination IP, destination port, protocol) information, packet filters for PDU sessions, related routing profile IDs, or N6 traffic routing information.

The PCF 121 may generate a packet data forwarding policy based on the traffic forwarding reference information received from the VCF 111. The packet data forwarding policy generated by the PCF 121 may be sent to the SMF 122.

The SMF 122 may generate a data forwarding rule such as the PDR and the FAR based on the generated packet data forwarding policy and send the data forwarding rule to the UPF 123.

In one embodiment, the PDR may include parameters related to packet duplication, and the FAR may include parameters related to packet duplication instruction. The UPF may identify the mirroring requirements of the SMF 122 from the parameters related to packet duplication within the PDR and/or the parameters related to the packet duplication instruction within the FAR, duplicate filtered packet data, and forward the duplicated packets to the target endpoint.

In one embodiment, the PDR may include information such as the Internet Protocol version 4 (IPv4), Internet Protocol version 6 (IPv6), and IPv4v6-based core network (CN) tunnel information on the PDU session type, network Instance, quality of service (QOS) flow identifier (QFI), IP packet filter set, application identifier, S-NSSAI, a UE identifier, a group of UEs, a random UE, and whether packet data is duplicated. For the Ethernet-based PDU session type, the PDR may include information such as the CN tunnel information, network instance, QFI, Ethernet packet filter set, S-NSSAI, a UE identifier, a group of UEs, a random UE, and whether packet data is duplicated. The FAR may include information such as forwarding operation information, forwarding target information, and whether the packet data is duplicated.

The UPF 123 may filter the packet data to be sent to the digital twin network 30 according to the PDR, duplicate the packet data identified by the filtering, and forward the duplicated packet data to the target endpoint within the digital twin network according to the FAR.

FIG. 5 illustrates a method for duplicating network traffic of the actual network and forwarding the duplicated network traffic to a digital twin network by the PCF 121, SMF 122, and UPF 123.

The VCF 111 may send the AI/ML model, which is a reliability evaluation target, to a twin instance within the digital twin network 30 S935. The VCF 111 may provide the AI/ML model to the twin instance within the digital twin network 30 based on the meta information of the AI/ML model received from the AnLF 11. The twin instance to which the AI/ML model is sent may be a twin instance supposed to use the AI/ML model (NWDAF twin instance including the AnLF) or a twin instance mapped to the AnLF 11 in the actual network.

The twin instance mapped to the AnLF 11 of the actual network may perform inference by deploying the sent AI/ML model S940 and providing the signal generated from the digital twin network 30 and forwarded duplicated traffic to the AI/ML model S945.

When simulation starts using the digital twin network 30 in which the AI/ML model is deployed, the VCF 111 may request the MEF 113 to perform reliability evaluation of the AI/ML model S950. At this time, the VCF 111 may send, to the MEF 113, evaluation-related information such as the AI/ML model ID, ID and information of the NF within the twin network in which the AI/ML model is deployed, the performance evaluation metric and the operational stability evaluation metric for reliability evaluation, evaluation period, evaluation duration, and a target endpoint to which to notify of the evaluation result.

In one embodiment, the VCF 111 may request the MEF 113 to perform reliability evaluation of the AI/ML model using Nmef_MLMoldelEvaluation_Subscribe service operation. Table 4 shows the information sent to the MEF 113 through the Nmef_MLMoldelEvaluation_Subscribe service operation.

The MEF 113 may start evaluation of the AI/ML model by receiving necessary information and using the performance evaluation metric and the operational stability evaluation metric received from the VCF 111 S955. The MEF 113 may collect necessary information from twin instances within the digital twin network 30 through the OAM 21 and/or from the actual network to measure the performance evaluation metric and the operational stability evaluation metric.

Once the information is collected, the MEF 113 may perform analysis of the performance evaluation metric and the operational stability evaluation metric and output the reliability evaluation result of the AI/ML model based on the collected information S960. When an internal policy is given in advance for the evaluation period and duration, or the entity requesting evaluation specifies the evaluation period and duration, the MEF 113 may perform evaluations periodically throughout the predetermined evaluation duration.

When the reliability evaluation result is generated, the MEF 113 may send the evaluation result to the VCF 111 S965. The VCF 111 may send the sent reliability evaluation result to the AnLF 11 S970, and the AnLF 11 may determine whether to use the AI/ML model based on the reliability evaluation result. In one embodiment, the AnLF 11 may use the AI/ML model which has satisfied the reliability evaluation criterion in the actual network S975.

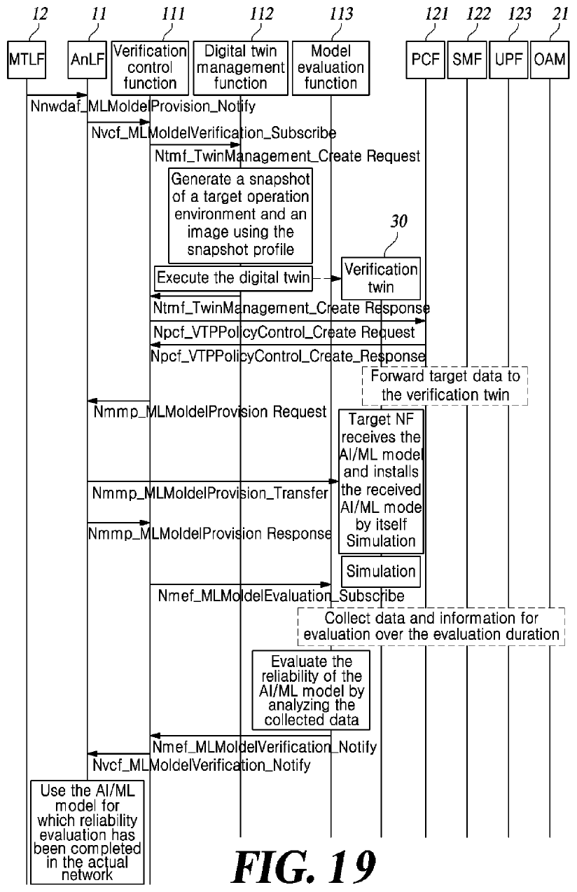

FIG. 19 is a flow diagram illustrating a method for verifying the reliability of an AI/ML model according to still yet further another embodiment.

Referring to FIG. 19, the AnLF 11 or the NWDAF including the AnLF 11 may receive an AI/ML model from the MTLF 12 or the NWDAF including the MTLF 12 S1005. In still yet further another embodiment, the AnLF 11 may receive an AI/ML model from the MTLF 12 through Nnwdaf_MLMoldelProvision_Subscribe service operation.

When the presence of the AI/ML model is confirmed, the AnLF 11 may request the VCF 111 to evaluate the reliability of the AI/ML model S1010. When the AnLF 11 requests the VCF 111 to evaluate the reliability of the AI/ML model, the Nvcf_MLModelVerification_Subscribe service operation may be used. Table 1 shows the information sent to the VCF 111 through the Nvcf_MLModelVerification_Subscribe service operation.

The AnLF 11 may send the network configuration reference information and evaluation-related parameters for evaluating the AI/ML model to the VCF 111. The evaluation-related parameters for evaluating the AI/ML model may include the performance evaluation metric and the operational stability evaluation metric of the AI/ML model, evaluation duration, and evaluation period.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the MAE, MAPE, MSE, and RMSE utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. To evaluate the operational stability of the AI/ML model, operational stability performance metrics, such as availability, security, scalability, and an indicator indicating whether inference time is within an acceptable range may be used.

The AnLF 11 may send information on the endpoint to which to send the meta information and evaluation results of the AI/ML model to be evaluated along with a reliability evaluation request. The meta information of the AI/ML model may include an identifier (ID) of the AI/ML model, the AI/ML model or the location where the AI/ML model is stored (e.g., URL), and information on the consumer NF of the AI/ML model. Also, the AnLF 11 may send the network configuration reference information and evaluation-related parameters of the AI/ML model received from the MTLF 12 to the VCF 111.

The VCF 111 may request the DTMF 112 to create a digital twin network for the operation of the AI/ML model S1015. When the VCF 111 requests a digital twin network from the DTMF 112, the Ndtmf_TwinManagement_Create service operation may be used. Table 2 shows the information sent from the VCF 111 to the DTMF 112 through the Ndtmf_TwinManagement_Create service operation.

The DTMF 112 may collect data required for the configuration of the twin network based on the network configuration reference information received from the VCF 111 and generate snapshots and images of the actual network based on the collected data S1020.

Generating a snapshot of the actual network is a technique used to create a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the DTMF 112 may execute the digital twin network that replicates the actual network by using the snapshot image S1025. Each constituting element of the digital twin network 30 may be executed as a twin instance and may be operated with the same configuration as each individual constituting element and in synchronization with the data mapped to the actual network. After executing the digital twin network 30, the DTMF 112 may send Ndtmf_TwinManagement_Create response to the VCF 111.

The VCF 111 may request the PCF 121 to perform generation of a forwarding policy and traffic forwarding so that the traffic of the actual network is duplicated and forwarded to the digital twin network 30 S1030. The VCF 111 may request the PCF 121 to perform generation of the forward policy and traffic forwarding by using Npcf_VTPolicyControl_Create service operation. Table 3 shows the information sent from the VCF 111 to the PCF 121 through the Npcf_VTPolicyControl_Create service operation.

When generation of a forwarding policy and traffic forwarding are requested, the VCF 111 may send traffic forwarding reference information, such as the ID of an entity that requests generation of a forwarding policy, the ID and address of a target endpoint to which filtered data are forwarded according to the forwarding policy, and a data filter context identifier, to the PCF 121.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a PDU session ID, S-NSSAI, DNN, RAT type, an internal group identifier, network area information, a MAC address of the target endpoint or IP 3-tuple (destination IP, destination port, protocol) information, packet filters for PDU sessions, related routing profile IDs, or N6 traffic routing information.

The PCF 121 may generate a packet data forwarding policy based on the traffic forwarding reference information received from the VCF 111. The packet data forwarding policy generated by the PCF 121 may be sent to the SMF 122.

The SMF 122 may generate a data forwarding rule such as the PDR and the FAR based on the generated packet data forwarding policy and send the data forwarding rule to the UPF 123.

In one embodiment, the PDR may include parameters related to packet duplication, and the FAR may include parameters related to packet duplication instruction. The UPF may identify the mirroring requirements of the SMF 122 from the parameters related to packet duplication within the PDR and/or the parameters related to the packet duplication instruction within the FAR, duplicate filtered packet data, and forward the duplicated packets to the target endpoint.

In one embodiment, the PDR may include information such as the Internet Protocol version 4 (IPv4), Internet Protocol version 6 (IPv6), and IPv4v6-based core network (CN) tunnel information on the PDU session type, network Instance, quality of service (QOS) flow identifier (QFI), IP packet filter set, application identifier, S-NSSAI, a UE identifier, a group of UEs, a random UE, and whether packet data is duplicated. For the Ethernet-based PDU session type, the PDR may include information such as the CN tunnel information, network instance, QFI, Ethernet packet filter set, S-NSSAI, a UE identifier, a group of UEs, a random UE, and whether packet data is duplicated. The FAR may include information such as forwarding operation information, forwarding target information, and whether the packet data is duplicated.

The UPF 123 may filter the packet data to be sent to the digital twin network 30 according to the PDR, duplicate the packet data identified by the filtering, and forward the duplicated packet data to the target endpoint within the digital twin network according to the FAR.

FIG. 5 illustrates a method for duplicating network traffic of the actual network and forwarding the duplicated network traffic to a digital twin network by the PCF 121, SMF 122, and UPF 123.

The VCF 111 may request the AnLF 11 to send the AI/ML model, which is a reliability evaluation target, to a twin instance (NWDAF twin instance including the AnLF) within the digital twin network 30 S1035. The twin instance to which the AI/ML model is sent may be a twin instance supposed to use the AI/ML model (NWDAF twin instance including the AnLF) or a twin instance mapped to the AnLF 11 in the actual network.

The VCF 111 may request the AnLF 11 to send the AI/ML model through the Nmmp_MLMoldelProvision_Request service operation. Table 5 shows the information sent to the AnLF 11 through the Nmmp_MLMoldelProvision_Request service operation, where the information may be sent from the VCF 111 to the AnLF 11 through a procedure other than the Nmmp_MLMoldelProvision_Request service operation.

The twin instance mapped to the AnLF 11 of the actual network may perform inference by deploying the sent AI/ML model and providing the signal generated from the digital twin network and forwarded duplicated traffic to the AI/ML model S1045.

When simulation starts using the digital twin network 30 in which the AI/ML model is deployed, the VCF 111 may request the MEF 113 to perform reliability evaluation of the AI/ML model S1050. At this time, the VCF 111 may send, to the MEF 113, evaluation-related information such as the AI/ML model ID, ID and information of the NF within the twin network in which the AI/ML model is deployed, the performance evaluation metric and the operational stability evaluation metric for reliability evaluation, evaluation period, evaluation duration, and a target endpoint to which to notify of the evaluation result.

In one embodiment, the VCF 111 may request the MEF 113 to perform reliability evaluation of the AI/ML model using Nmef_MLMoldelEvaluation_Subscribe service operation. Table 4 shows the information to MEF sent the 113 through the Nmef_MLMoldelEvaluation_Subscribe service operation. The information of Table 4 may be sent from the VCF 111 to the MEF 113 through a procedure other than the Nmef_MLMoldelEvaluation_Subscribe service operation.

The MEF 113 may start evaluation of the AI/ML model by receiving necessary information and using the performance evaluation metric and the operational stability evaluation metric received from the VCF 111 S1055. The MEF 113 may collect necessary information from twin instances within the digital twin network 30 through the OAM 21 and/or from the actual network to measure the performance evaluation metric and the operational stability evaluation metric.

Once the information is collected, the MEF 113 may perform analysis of the performance evaluation metric and the operational stability evaluation metric and output the evaluation result S1060. When an internal policy is given in advance for the evaluation period and duration, or the entity requesting evaluation specifies the evaluation period and duration, the MEF 113 may perform evaluations periodically throughout the predetermined evaluation duration.

When the reliability evaluation result is generated, the MEF 113 may send the evaluation result to the VCF 111 S1065. The VCF 111 may send the sent reliability evaluation result to the AnLF 11 S1070, and the AnLF 11 may determine whether to use the AI/ML model based on the reliability evaluation result. In one embodiment, the AnLF 11 may use the AI/ML model which has satisfied the reliability evaluation criterion in the actual network S1075.

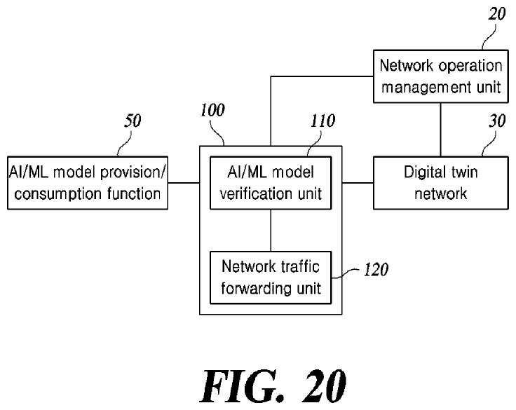

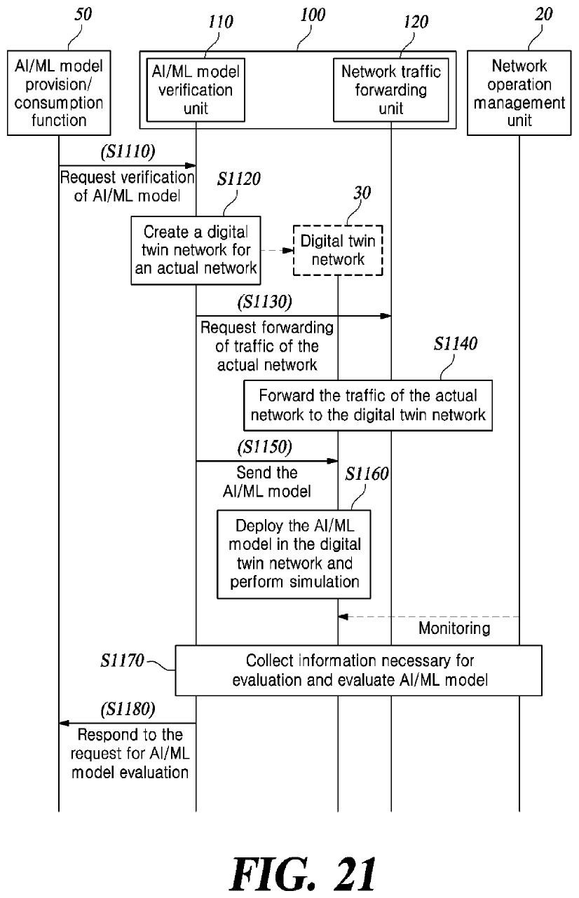

FIG. 20 shows a block diagram of a system for verifying the reliability of an AI/ML model according to yet still further another embodiment, and FIG. 21 is a flow diagram illustrating a method for verifying the reliability of an AI/ML model according to even yet another embodiment.

Referring to FIG. 20, a system for verifying the reliability of an AI/ML model according to yet still further another embodiment may include an AI/ML model provision/consumption function 50 which provides and consumes an AI/ML model, an apparatus 100 for verifying the reliability of an AI/ML model, and a network operation management unit 20. The apparatus 100 for verifying the reliability of an AI/ML model may include an AI/ML model verification unit 110 and a network traffic forwarding unit 120.

The apparatus 100 for verifying the reliability of an AI/ML model may be operated in the actual network environment and verify the reliability of the AI/ML model provided by the AI/ML model provision/consumption function 50.

The AI/ML model provision/consumption function 50 may develop, learn, and train an AI/ML model, determine whether to use the AI/ML model based on the reliability verification result of the AI/ML model, and perform inference using the AI/ML model.

The AI/ML model verification unit 110 of the reliability verification apparatus 100 may verify the reliability of the AI/ML model by evaluating the AI/ML model provided by the AI/ML model provision/consumption function 50 according to the performance evaluation metric and the operational stability evaluation metric.

To verify the reliability of the AI/ML model, the network traffic forwarding unit 120 duplicates the entire or a portion of the network traffic from the actual network environment in which the AI/ML model is to be deployed and operated; and forwards the duplicated network traffic to the digital twin network 30 that replicates the whole or part of the actual network environment.

The network operation management unit 20 may monitor the actual network environment and the environment of the digital twin network 30.

The digital twin network 30 is intended to verify the reliability of an AI/ML model, which is a network that replicates the whole or part of the actual network environment in which the AI/ML model is deployed and operated.

Referring to FIG. 21, the AI/ML model provision/consumption function 50 may provide an AI/ML model to the AI/ML model verification unit 110 S1110. The AI/ML model provision/consumption function 50 may send the location information of the AI/ML model to the reliability verification apparatus 100 so that the reliability verification apparatus 100 downloads the AI/ML model from storage corresponding to the location information.

In yet still further another embodiment, the AI/ML model provision/consumption function 50 may send the network configuration reference information to the reliability verification apparatus 110 together with the AI/ML model. Also, the AI/ML model provision/consumption function 50 may send the parameters for evaluating the reliability of the AI/ML model to the reliability verification apparatus 100. The parameters for evaluating the reliability of the AI/ML model may include a performance evaluation metric and an operational stability evaluation metric of the AI/ML model, an evaluation duration, and/or an evaluation period.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the Mean Absolute Error (MAE), Mean Absolute Percentage Error (MAPE), Mean Squared Error (MSE), and Root Mean Squared Error (RMSE) utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. In one embodiment, the performance metric of the operational stability of the AI/ML model may include indicators such as availability, security, scalability, and whether inference time is within an acceptable range.

The AI/ML model verification unit 110 may create a twin network that replicates the actual network based on the network configuration reference information received from the AI/ML model provision/consumption function 50 S1120.

The AI/ML model verification unit 110 may collect data required for the configuration of the twin network and generate snapshots and images of the actual network based on the collected data. Generating a snapshot of the actual network is a technique used to generate a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the AI/ML model verification unit 110 may execute the digital twin network 30 that replicates the actual network by using the snapshot and image of the actual network. Each constituting element of the digital twin network 30 may be executed as a twin instance, and the digital twin network 30 may be operated in synchronization with the actual network using the same configurations and data applied to the individual constituting elements of the actual network.

The AI/ML model verification unit 110 may request the network traffic forwarding unit 120 to perform generation of a forwarding policy and traffic forwarding for mirroring the traffic of the actual network (duplication of the actual network traffic and forwarding of the duplicated traffic to the digital twin network 30) S1130.

The AI/ML model verification unit 110 may send the traffic forwarding reference information to the network traffic forwarding unit 120 when requesting the generation of the forwarding policy and traffic forwarding. The traffic forwarding reference information may include the identifier of an entity (e.g., the AI/ML model verification unit 110) requesting the generation of the forwarding policy, the identifier of a target endpoint to which filtered data is forwarded according to the forwarding policy and the address of the target endpoint (which is included within the digital twin network 30), and a data filter context identifier.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a protocol data unit (PDU) session ID, single-network slice selection assistance information (S-NSSAI), data network name (DNN), radio access technology (RAT) type, an internal group identifier, network area information, a media access control (MAC) address of the target endpoint or IP 3-tuple (destination IP, destination port, protocol) information, packet filters for PDU sessions, related routing profile IDs, or N6 traffic routing information.

When the network traffic forwarding unit 120 generate a packet data forwarding policy based on the traffic forwarding reference information received from the AI/ML model verification unit 110 and sends the generated packet data forwarding policy to the user plane function (UPF), the UPF may forward the traffic of the actual network to the digital twin network based on the packet data forwarding policy S1140.

The network traffic forwarding unit 120 may generate a data forwarding rule such as the packet detection rule (PDR) and the forwarding action rule (FAR) based on the generated packet data forwarding policy and send the data forwarding rule to the UPF. The UPF may filter the packet data to be sent to the digital twin network 30 according to the PDR, duplicate the packet data identified by the filtering, and forward the duplicated packet data to the target endpoint within the digital twin network according to the FAR.

In one embodiment, the PDR may include parameters related to packet duplication, and the FAR may include parameters related to packet duplication instruction. The UPF may identify the mirroring requirements of the network traffic forwarding unit 120 from the parameters related to packet duplication within the PDR and/or the parameters related to the packet duplication instruction within the FAR, duplicate filtered packet data, and forward the duplicated packets to the target endpoint.

The AI/ML model verification unit 110 may send the AI/ML model, which is a reliability evaluation target, to the digital twin network 30 S1150. In one embodiment, the AI/ML model verification unit 110 may send the AI/ML model to a target twin instance supposed to use the AI/ML model among twin instances in the digital twin network. The target twin instance may be a twin instance mapped to the AI/ML model provision function 40 in the actual network.

The digital twin network 30 may deploy the AI/ML model and perform simulation using the traffic forwarded from the actual network S1160. In other words, the target twin instance may perform inference by deploying the sent AI/ML model and providing the signal generated from the digital twin network 30 and forwarded duplicated traffic to the AI/ML model.

When the digital twin network 30 in which the AI/ML model has been deployed starts simulation using the AI/ML model, the AI/ML model verification unit 110 may evaluate the AI/ML model based on the performance evaluation metric and the operational stability evaluation metric received from the AI/ML model provision/consumption function 50 S1170.

The AI/ML model verification unit 110 may collect necessary information from twin instances within the digital twin network 30 through the network operation management unit 20 and/or from the actual network to measure the performance evaluation metric and the operational stability evaluation metric.

Once the information is collected, the AI/ML model verification unit 110 may evaluate the AI/ML model using the performance evaluation metric and the operational stability evaluation metric and generate an evaluation result. When an internal policy is given in advance for the evaluation period and duration, or the entity requesting evaluation specifies the evaluation period and duration, the AI/ML model verification unit 110 may perform evaluations periodically throughout the specified evaluation duration.

When the reliability evaluation result is generated, the AI/ML model verification unit 110 may send the AI/ML model and the evaluation result of the corresponding AI/ML model to the AI/ML model provision/consumption function 50 S1180.

In yet still further another embodiment, the AI/ML model provision/consumption function 50 may include at least one of the NWDAF, NWDAF including the MTLF, NWDAF including the AnLF, and NF in which an AI/ML model is embedded; the AI/ML model provision/consumption function 50 may be an entity that provides or consumes an AI/ML model.

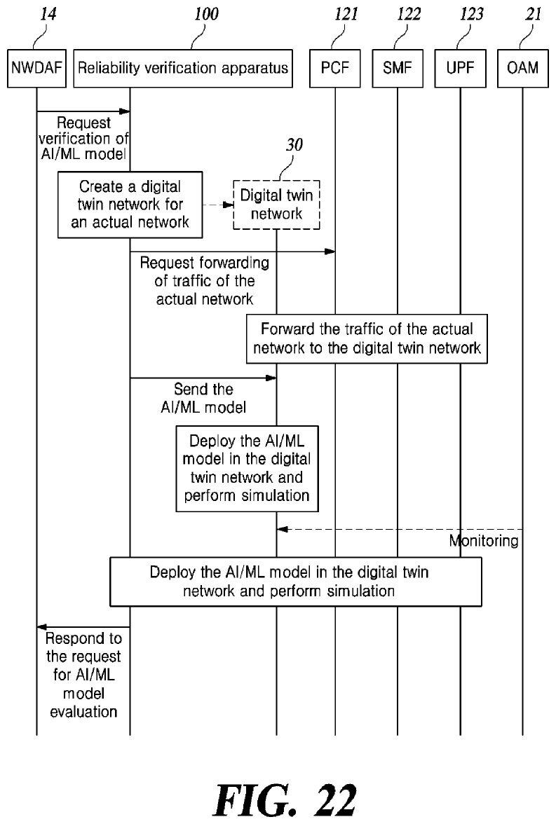

FIG. 22 is a flow diagram illustrating a method for verifying the reliability of an AI/ML model according to even still another embodiment.

Referring to FIG. 22, the NWDAF 14 may request the reliability verification apparatus 100 to verify the reliability of an AI/ML model S1210. The NWDAF 14 may provide an AI/ML model whose reliability is to be verified to the reliability verification apparatus 100. Alternatively, the NWDAF 14 may send the location information of the AI/ML model to the reliability verification apparatus 100 so that the reliability verification apparatus 100 downloads the AI/ML model from storage corresponding to the location information.

The NWDAF 14 may send the network configuration reference information to the reliability verification apparatus 100. The NWDAF 14 may send evaluation-related parameters for evaluating an AI/ML model, such as the performance evaluation metric and the operational stability evaluation metric of the AI/ML model, evaluation duration, and evaluation period, to the reliability verification apparatus 100.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the MAE, MAPE, MSE, and RMSE utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. To evaluate the operational stability of the AI/ML model, operational stability performance metrics, such as availability, security, scalability, and an indicator indicating whether inference time is within an acceptable range may be used.

The reliability verification apparatus 100 may create a twin network that replicates the actual network based on the network configuration reference information received from the NWDAF 14 S1220.

To create a digital twin network, the reliability verification apparatus 100 may collect data required for the configuration of the twin network and generate snapshots and images of the actual network based on the collected data. Generating a snapshot of the actual network is a technique used to create a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the reliability verification apparatus 100 may execute the digital twin network 30 that replicates the actual network by using the snapshot and image of the actual network. Each constituting element of the digital twin network 30 may be executed as a twin instance, and the digital twin network 30 may be operated in synchronization with the actual network using the same configurations and data applied to the individual constituting elements of the actual network.

The reliability verification apparatus 100 may request the PCF 121 to perform generation of a forwarding policy and traffic forwarding for mirroring the traffic of the actual network (duplication of the actual network traffic and forwarding of the duplicated traffic to the digital twin network 30) S1230.

Afterward, the PCF 121, SMF 122, and UPF 123 may forward the traffic of the actual network to the digital twin network according to the request of the reliability verification apparatus 100 S1240. FIG. 5 illustrates a method for replicating network traffic of an actual network by the PCF 121, SMF 122, and UPF 123 and forwarding the duplicated network traffic to a digital twin network.

The reliability verification apparatus 100 may send the traffic forwarding reference information to the PCF 121 when requesting the generation of the forwarding policy and traffic forwarding. The traffic forwarding reference information may include the identifier of an entity (e.g., the reliability verification apparatus) requesting the generation of the forwarding policy, the identifier of a target endpoint to which filtered data is forwarded according to the forwarding policy and the address of the target endpoint (which is included within the digital twin network 30), and a data filter context identifier.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a PDU session ID, S-NSSAI, DNN, RAT type, an internal group identifier, network area information, a MAC address of the target endpoint or IP 3-tuple (destination IP, destination port, protocol) information, packet filters for PDU sessions, related routing profile IDs, or N6 traffic routing information.

The PCF 121 may generate a packet data forwarding policy based on the traffic forwarding reference information received from the reliability verification apparatus 100. The PCF 121 may send the generated packet data forwarding policy to the SMF 122.

The SMF 122 may generate a data forwarding rule such as the PDR and the FAR based on the generated packet data forwarding policy and send the data forwarding rule to the UPF 123.

In one embodiment, the PDR may include parameters related to packet duplication, and the FAR may include parameters related to packet duplication instruction. The UPF may identify the mirroring requirements of the SMF 122 from the parameters related to packet duplication within the PDR and/or the parameters related to the packet duplication instruction within the FAR, duplicate filtered packet data, and forward the duplicated packets to the target endpoint.

In one embodiment, the PDR may include information such as the Internet Protocol version 4 (IPv4), Internet Protocol version 6 (IPv6), and IPv4v6-based core network (CN) tunnel information on the PDU session type, network Instance, quality of service (QOS) flow identifier (QFI), IP packet filter set, application identifier, S-NSSAI, a UE identifier, a group of UEs, a random UE, and whether packet data is duplicated. For the Ethernet-based PDU session type, the PDR may include information such as the CN tunnel information, network instance, QFI, Ethernet packet filter set, S-NSSAI, a UE identifier, a group of UEs, a random UE, and whether packet data is duplicated. The FAR may include information such as forwarding operation information, forwarding target information, and whether the packet data is duplicated.

The UPF 123 may filter the packet data to be sent to the digital twin network 30 according to the PDR, duplicate the packet data identified by the filtering, and forward the duplicated packet data to the target endpoint within the digital twin network according to the FAR.

The reliability verification apparatus 100 may send the AI/ML model, which is a reliability evaluation target, to the digital twin network 30 S1250. In one embodiment, the reliability verification apparatus 100 may send the AI/ML model to a target twin instance (the twin instance of NWDAF) supposed to use the AI/ML model among twin instances in the digital twin network. The target twin instance may be a twin instance mapped to the AnLF 11 in the actual network.

The twin instance corresponding to the NWDAF 14 may deploy the AI/ML model and perform simulation using the traffic forwarded from the actual network S1260. In other words, the target twin instance may perform inference by deploying the sent AI/ML model and providing the signal generated from the digital twin network 30 and forwarded duplicated traffic to the AI/ML model.

When the digital twin network 30 in which the AI/ML model has been deployed starts simulation using the AI/ML model, the reliability verification apparatus 100 may evaluate the AI/ML model based on the performance evaluation metric and the operational stability evaluation metric received from the NWDAF 14 S1270.

The reliability verification apparatus 100 may collect necessary information (information used for measuring the performance evaluation metric and the operational stability evaluation metric) from twin instances within the digital twin network 30 through the OAM 21 and/or from the actual network to measure the performance evaluation metric and the operational stability evaluation metric.

Once the information is collected, the reliability verification apparatus 100 may evaluate the AI/ML model and generate an evaluation result using the performance evaluation metric and the operational stability evaluation metric based on the collected information. When an internal policy is given in advance for the evaluation period and duration, or the entity requesting evaluation specifies the evaluation period and duration, the reliability verification apparatus 100 may perform evaluations periodically throughout the specified evaluation duration.

When a reliability evaluation result is generated, the reliability verification apparatus 100 may send the AI/ML model and the evaluation result of the corresponding AI/ML model to the NWDAF 14 S1280.

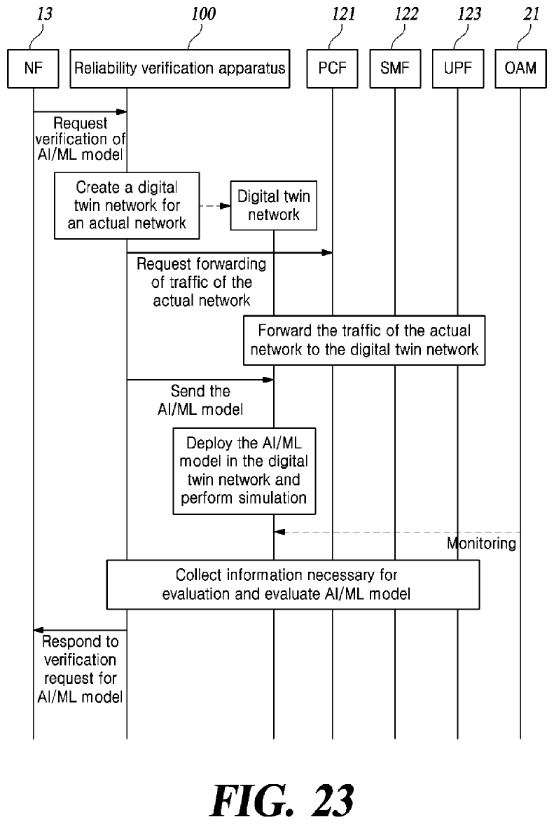

FIG. 23 is a flow diagram illustrating a method for verifying the reliability of an AI/ML model according to even yet another embodiment.

Referring to FIG. 23, the NF 13 may request the reliability verification apparatus 100 to verify the reliability of an AI/ML model S1310. The NF 13 may provide an AI/ML model whose reliability is to be verified to the reliability verification apparatus 100. Alternatively, the NF 13 may send the location information of the AI/ML model to the reliability verification apparatus 100 so that the reliability verification apparatus 100 downloads the AI/ML model from storage corresponding to the location information.

The NF 13 may send the network configuration reference information to the reliability verification apparatus 100 while providing an AI/ML model. Also, the NF 13 may send evaluation-related parameters for evaluating an AI/ML model, such as the performance evaluation metric and the operational stability evaluation metric of the AI/ML model, evaluation duration, and evaluation period, to the reliability verification apparatus 100.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the MAE, MAPE, MSE, and RMSE utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. To evaluate the operational stability of the AI/ML model, operational stability performance metrics, such as availability, security, scalability, and an indicator indicating whether inference time is within an acceptable range may be used.

The reliability verification apparatus 100 may create a twin network that replicates the actual network based on the network configuration reference information received from the NF 13 S1320.

The reliability verification apparatus 100 may collect data required for the configuration of the twin network and generate snapshots and images of the actual network based on the collected data. Generating a snapshot of the actual network is a technique used to create a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the reliability verification apparatus 100 may execute the digital twin network 30 that replicates the actual network by using the snapshot and image of the actual network. Each constituting element of the digital twin network 30 may be executed as a twin instance, and the digital twin network 30 may be operated in synchronization with the actual network using the same configurations and data applied to the individual constituting elements of the actual network.

The reliability verification apparatus 100 may request the PCF 121 to perform generation of a forwarding policy and traffic forwarding for mirroring the traffic of the actual network (duplication of the actual network traffic and forwarding of the duplicated traffic to the digital twin network 30) S1330.

Afterward, the PCF 121, SMF 122, and UPF 123 may forward the traffic of the actual network to the digital twin network according to the request of the reliability verification apparatus 100 S1340. FIG. 5 illustrates a method for replicating network traffic of an actual network by the PCF 121, SMF 122, and UPF 123 and forwarding the duplicated network traffic to a digital twin network.

The reliability verification apparatus 100 may send the traffic forwarding reference information to the PCF 121 when requesting the generation of the forwarding policy and traffic forwarding. The traffic forwarding reference information may include the identifier of an entity (e.g., the reliability verification apparatus) requesting the generation of the forwarding policy, the identifier of a target endpoint to which filtered data is forwarded according to the forwarding policy and the address of the target endpoint (which is included within the digital twin network 30), and a data filter context identifier.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a PDU session ID, S-NSSAI, DNN, RAT type, an internal group identifier, network area information, a MAC address of the target endpoint or IP 3-tuple (destination IP, destination port, protocol) information, packet filters for PDU sessions, related routing profile IDs, or N6 traffic routing information.

The PCF 121 may generate a packet data forwarding policy based on the traffic forwarding reference information received from the reliability verification apparatus 100. The PCF 121 may send the generated packet data forwarding policy to the SMF 122.

The SMF 122 may generate a data forwarding rule such as the PDR and the FAR based on the generated packet data forwarding policy and send the data forwarding rule to the UPF 123.

In one embodiment, the PDR may include parameters related to packet duplication, and the FAR may include parameters related to packet duplication instruction. The UPF may identify the mirroring requirements of the SMF 122 from the parameters related to packet duplication within the PDR and/or the parameters related to the packet duplication instruction within the FAR, duplicate filtered packet data, and forward the duplicated packets to the target endpoint.

In one embodiment, the PDR may include information such as the Internet Protocol version 4 (IPv4), Internet Protocol version 6 (IPv6), and IPv4v6-based core network (CN) tunnel information on the PDU session type, network Instance, quality of service (QOS) flow identifier (QFI), IP packet filter set, application identifier, S-NSSAI, a UE identifier, a group of UEs, a random UE, and whether packet data is duplicated. For the Ethernet-based PDU session type, the PDR may include information such as the CN tunnel information, network instance, QFI, Ethernet packet filter set, S-NSSAI, a UE identifier, a group of UEs, a random UE, and whether packet data is duplicated. The FAR may include information such as forwarding operation information, forwarding target information, and whether the packet data is duplicated.

The UPF 123 may filter the packet data to be sent to the digital twin network 30 according to the PDR, duplicate the packet data identified by the filtering, and forward the duplicated packet data to the target endpoint within the digital twin network according to the FAR.

The reliability verification apparatus 100 may send the AI/ML model, which is a reliability evaluation target, to the digital twin network 30 S1350. In even yet another embodiment, the reliability verification apparatus 100 may send the AI/ML model to a target twin instance (the twin instance of NF) supposed to use the AI/ML model among twin instances in the digital twin network. The target twin instance may be a twin instance mapped to the NF in the actual network.

The twin instance corresponding to the NF may deploy the AI/ML model and perform simulation using the traffic forwarded from the actual network S1360. In other words, the target twin instance may perform inference by deploying the sent AI/ML model and providing the signal generated from the digital twin network 30 and forwarded duplicated traffic to the AI/ML model.

When the digital twin network 30 in which the AI/ML model has been deployed starts simulation using the AI/ML model, the reliability verification apparatus 100 may evaluate the AI/ML model based on the performance evaluation metric and the operational stability evaluation metric received from the NF 13 S1370.

The reliability verification apparatus 100 may collect necessary information (information necessary for evaluating the reliability of the AI/ML model) from twin instances within the digital twin network 30 through the OAM 21 and/or from the actual network to measure the performance evaluation metric and the operational stability evaluation metric.

Once the information is collected, the reliability verification apparatus 100 may evaluate the AI/ML model and generate an evaluation result using the performance evaluation metric and the operational stability evaluation metric based on the collected information. When an internal policy is given in advance for the evaluation period and duration, or the entity requesting evaluation specifies the evaluation period and duration, the reliability verification apparatus 100 may perform evaluations periodically throughout the specified evaluation duration.

When a reliability evaluation result is generated, the reliability verification apparatus 100 may send the AI/ML model and the evaluation result of the corresponding AI/ML model to the NF 13 S1380.

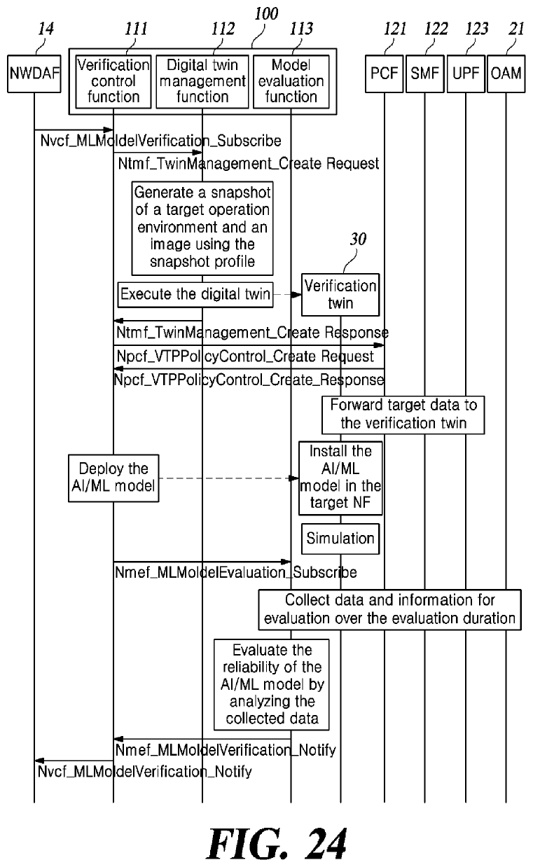

FIG. 24 is a flow diagram illustrating a method for verifying the reliability of an AI/ML model according to even yet still another embodiment.

Referring to FIG. 24, the NWDAF 14 may request the VCF 11 to evaluate the reliability of an AI/ML model S1405.

At this time, the network configuration reference information and evaluation-related parameters for evaluating the AI/ML model may be sent to the VCF 111. The evaluation-related parameters for evaluating the AI/ML model may include the performance evaluation metric and the operational stability evaluation metric of the AI/ML model, evaluation duration, and evaluation period.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the MAE, MAPE, MSE, and RMSE utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. To evaluate the operational stability of the AI/ML model, operational stability performance metrics, such as availability, security, scalability, and an indicator indicating whether inference time is within an acceptable range may be used.

When the NWDAF 14 requests the VCF 111 to evaluate the reliability of the AI/ML model, the Nvcf_MLModelVerification_Subscribe service operation may be used. Table 1 shows the information sent to the VCF 111 through the Nvcf_MLModelVerification_Subscribe service operation.

The NWDAF 14 may send information on the endpoint to which to send the meta information and evaluation results of the AI/ML model to be evaluated along with a reliability evaluation request. The meta information of the AI/ML model may include an identifier (ID) of the AI/ML model, the AI/ML model or the location where the AI/ML model is stored (e.g., URL), and information on the consumer NF of the AI/ML model. Also, the NWDAF 14 may send the network configuration reference information and evaluation-related parameters of the AI/ML model to the VCF 111.

The VCF 111 may request the DTMF 112 to create a digital twin network for the operation of the AI/ML model S1410. When the VCF 111 requests a digital twin network from the DTMF 112, the Ndtmf_TwinManagement_Create service operation may be used. Table 2 shows the information sent to the DTMF 112 through the Ndtmf_TwinManagement_Create service operation.

The DTMF 112 may collect data required for the configuration of the twin network based on the network configuration reference information received from the VCF 111 and generate snapshots and images of the actual network based on the collected data S1415.

Generating a snapshot of the actual network is a technique used to create a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the DTMF 112 may execute the digital twin network that replicates the actual network by using the snapshot image S1420. Each constituting element of the digital twin network 30 may be executed as a twin instance and may be operated with the same configuration as each individual constituting element and in synchronization with the data mapped to the actual network. After executing the digital twin network 30, the DTMF 112 may send Ndtmf_TwinManagement_Create response to the VCF 111.

The VCF 111 may request the PCF 121 to perform generation of a forwarding policy and traffic forwarding so that the traffic of the actual network is duplicated and forwarded to the digital twin network 30 S1425. The VCF 111 may request the PCF 121 to perform generation of the forward policy and traffic forwarding by using Npcf_VTPolicyControl_Create service operation.

Table 3 shows the information sent from the VCF 111 to the PCF 121 through the Npcf_VTPolicyControl_Create service operation.

When generation of a forwarding policy and traffic forwarding are requested, the VCF 111 may send traffic forwarding reference information, such as the ID of an entity that requests generation of a forwarding policy, the ID and address of a target endpoint to which filtered data are forwarded according to the forwarding policy, and a data filter context identifier, to the PCF 121.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a PDU session ID, S-NSSAI, DNN, RAT type, an internal group identifier, network area information, a MAC address of the target endpoint or IP 3-tuple (destination IP, destination port, protocol) information, packet filters for PDU sessions, related routing profile IDs, or N6 traffic routing information.

The PCF 121 may generate a packet data forwarding policy based on the traffic forwarding reference information received from the VCF 111. The packet data forwarding policy generated by the PCF 121 may be sent to the SMF 122.

The SMF 122 may generate a data forwarding rule such as the PDR and the FAR based on the generated packet data forwarding policy and send the data forwarding rule to the UPF 123.

In one embodiment, the PDR may include parameters related to packet duplication, and the FAR may include parameters related to packet duplication instruction. The UPF may identify the mirroring requirements of the SMF 122 from the parameters related to packet duplication within the PDR and/or the parameters related to the packet duplication instruction within the FAR, duplicate filtered packet data, and forward the duplicated packets to the target endpoint.

In one embodiment, the PDR may include information such as the Internet Protocol version 4 (IPv4), Internet Protocol version 6 (IPv6), and IPv4v6-based core network (CN) tunnel information on the PDU session type, network Instance, quality of service (QOS) flow identifier (QFI), IP packet filter set, application identifier, S-NSSAI, a UE identifier, a group of UEs, a random UE, and whether packet data is duplicated. For the Ethernet-based PDU session type, the PDR may include information such as the CN tunnel information, network instance, QFI, Ethernet packet filter set, S-NSSAI, a UE identifier, a group of UEs, a random UE, and whether packet data is duplicated. The FAR may include information such as forwarding operation information, forwarding target information, and whether the packet data is duplicated.

The UPF 123 may filter the packet data to be sent to the digital twin network 30 according to the PDR, duplicate the packet data identified by the filtering, and forward the duplicated packet data to the target endpoint within the digital twin network according to the FAR.

FIG. 5 illustrates a method for duplicating network traffic of the actual network and forwarding the duplicated network traffic to a digital twin network by the PCF 121, SMF 122, and UPF 123.

The VCF 111 may send the AI/ML model, which is a reliability evaluation target, to a twin instance within the digital twin network 30 S1430. The VCF 111 may provide the AI/ML model to the twin instance within the digital twin network 30 based on the meta information of the AI/ML model received from the NWDAF 14. The twin instance to which the AI/ML model is sent may be a twin instance supposed to use the AI/ML model (twin instance of the NWDAF) or a twin instance mapped to the NWDAF 14 in the actual network.

The twin instance mapped to the NWDAF 14 of the actual network may perform inference by deploying the sent AI/ML model S1435 and providing the signal generated from the digital twin network 30 and forwarded duplicated traffic to the AI/ML model S1440.

When simulation starts using the digital twin network 30 in which the AI/ML model is deployed, the VCF 111 may request the MEF 113 to perform reliability evaluation of the AI/ML model S1445. At this time, the VCF 111 may send, to the MEF 113, evaluation-related information such as the AI/ML model ID, ID and information of the NF within the twin network in which the AI/ML model is deployed, the performance evaluation metric and the operational stability evaluation metric for reliability evaluation, evaluation period, evaluation duration, and a target endpoint to which to notify of the evaluation result.

In one embodiment, the VCF 111 may request the MEF 113 to perform reliability evaluation of the AI/ML model using Nmef_MLMoldelEvaluation_Subscribe service operation. Table 4 shows the information sent to the MEF 113 through the Nmef_MLMoldelEvaluation_Subscribe service operation.

The MEF 113 may start evaluation of the AI/ML model by receiving necessary information and using the performance evaluation metric and the operational stability evaluation metric received from the VCF 111 S1450. The MEF 113 may collect necessary information from twin instances within the digital twin network 30 through the OAM 21 and/or from the actual network to measure the performance evaluation metric and the operational stability evaluation metric.

Once the information is collected, the MEF 113 may perform analysis of the AI/ML model using the performance evaluation metric and the operational stability evaluation metric and output the reliability evaluation result of the AI/ML model based on the collected information S1455. When an internal policy is given in advance for the evaluation period and duration, or the entity requesting evaluation specifies the evaluation period and duration, the MEF 113 may perform evaluations periodically throughout the predetermined evaluation duration.

When the reliability evaluation result is generated, the MEF 113 may send the evaluation result to the VCF 111 S1460. The VCF 111 may send the sent reliability evaluation result to the NWDAF 14 S1465. The NWDAF 14 may determine whether to use the AI/ML model based on the reliability evaluation result. In one embodiment, the NWDAF 14 may use the AI/ML model which has satisfied the reliability evaluation criterion in the actual network.

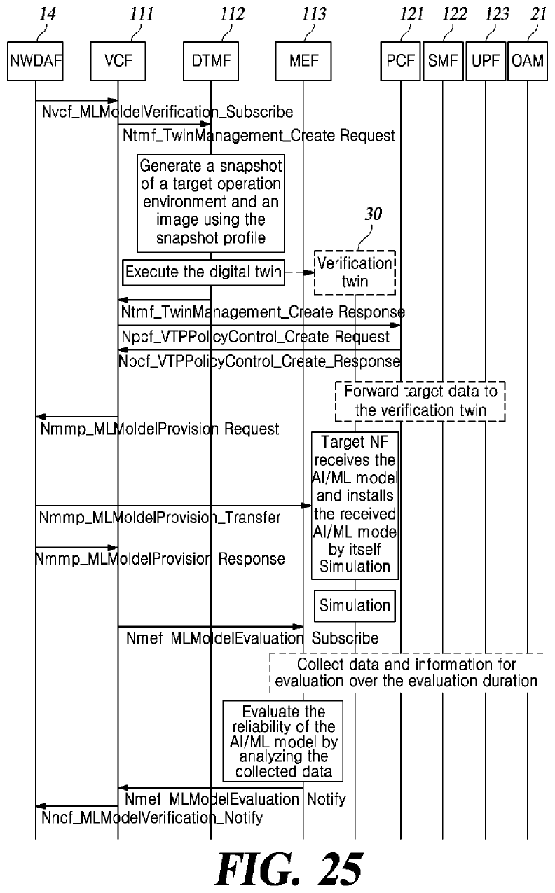

FIG. 25 is a flow diagram illustrating a method for verifying the reliability of an AI/ML model according to even still yet another embodiment.

Referring to FIG. 25, the NWDAF 14 may request the VCF 111 to evaluate the reliability of an AI/ML model S1505. When the NWDAF 14 requests the VCF 111 to evaluate the reliability of the AI/ML model, the Nvcf_MLModelVerification_Subscribe service operation may be used. Table 1 shows the information sent to the VCF 111 through the Nvcf_MLModelVerification_Subscribe service operation.

The NWDAF 14 may send the network configuration reference information and evaluation-related parameters for evaluating an AI/ML model to the VCF 111. The evaluation-related parameters for evaluating the AI/ML model may include the performance evaluation metric and the operational stability evaluation metric of the AI/ML model, evaluation duration, and evaluation period.

The network configuration reference information may include an identifier of the actual network, NF instance information of the actual network, context information including the information on the actual network, a web address from which information on the actual network may be obtained (e.g., the uniform resource locator (URL) address), and location information (e.g., the uniform resource identifier (URI)). The network configuration reference information may include meta information which may be used directly to configure a digital twin that replicates the actual network or meta data which may be used to obtain necessary information for configuring the digital twin. For example, the information which may be used for configuring a digital twin of the actual network may include filter information for filtering only the instance constituting a digital twin network of the actual network.

In one embodiment, the performance evaluation metric of the AI/ML model may vary depending on the algorithm employed for the development of the AI/ML model and inference values generated by the AI/ML model. For example, a regression model may use various performance evaluation metrics such as the MAE, MAPE, MSE, and RMSE utilizing statistical values between actual and predicted values. For the evaluation of a classification model, various performance evaluation metrics such as accuracy, precision, recall, and F1 score may be used.

The operational stability metric of the AI/ML model is intended to verify whether a problem occurs when the AI/ML model is executed. To evaluate the operational stability of the AI/ML model, operational stability performance metrics, such as availability, security, scalability, and an indicator indicating whether inference time is within an acceptable range may be used.

The NWDAF 14 may send information on the endpoint to which to send the meta information and evaluation results of the AI/ML model to be evaluated along with a reliability evaluation request. The meta information of the AI/ML model may include an identifier (ID) of the AI/ML model, the AI/ML model or the location where the AI/ML model is stored (e.g., URL), and information on the consumer NF of the AI/ML model. Also, the NWDAF 14 may send the network configuration reference information and evaluation-related parameters of the AI/ML model to the VCF 111.

The VCF 111 may request the DTMF 112 to create a digital twin network for the operation of the AI/ML model S1510. When the VCF 111 requests a digital twin network from the DTMF 112, the Ndtmf_TwinManagement_Create service operation may be used. Table 2 shows the information sent to the DTMF 112 through the Ndtmf_TwinManagement_Create service operation.

The DTMF 112 may collect data required for the configuration of the twin network based on the network configuration reference information received from the VCF 111 and generate snapshots and images of the actual network based on the collected data S1515.

Generating a snapshot of the actual network is a technique used to create a new image from a network instance, and the image of the actual network is a file containing an executable virtual disk, which may be considered as a common concept in the digital twin field. An image of the actual network may include components (e.g., NFs, access networks, and user equipment (UE)) of the actual network, settings for each individual component, and data.

When image generation is completed, the DTMF 112 may execute the digital twin network that replicates the actual network by using the snapshot image S1520. Each constituting element of the digital twin network 30 may be executed as a twin instance and may be operated with the same configuration as each individual constituting element and in synchronization with the data mapped to the actual network. After executing the digital twin network 30, the DTMF 112 may send Ndtmf_TwinManagement_Create response to the VCF 111.

The VCF 111 may request the PCF 121 to perform generation of a forwarding policy and traffic forwarding so that the traffic of the actual network is duplicated and forwarded to the digital twin network 30 S1525. The VCF 111 may request the PCF 121 to perform generation of the forward policy and traffic forwarding by using Npcf_VTPolicyControl_Create service operation. Table 3 shows the information sent from the VCF 111 to the PCF 121 through the Npcf_VTPolicyControl_Create service operation.

When generation of a forwarding policy and traffic forwarding are requested, the VCF 111 may send traffic forwarding reference information, such as the ID of an entity that requests generation of a forwarding policy, the ID and address of a target endpoint to which filtered data are forwarded according to the forwarding policy, and a data filter context identifier, to the PCF 121.

The forwarding policy and traffic forwarding may correspond to the policy and action for duplicating packet data of the actual network and forwarding the duplicated data to a target endpoint on the digital twin network 30. In one embodiment, traffic forwarding may be performed through a network packet duplication and forwarding technique, such as a port mirroring technique in which a network packet sent to a mirrored port of a network switch is duplicated to another port (mirroring port).

The data filter context may include information required to generate a data forwarding policy, such as a PDU session ID, S-NSSAI, DNN, RAT type, an internal group identifier, network area information, a MAC address of the target endpoint or IP 3-tuple (destination IP, destination port, protocol) information, packet filters for PDU sessions, related routing profile IDs, or N6 traffic routing information.

The PCF 121 may generate a packet data forwarding policy based on the traffic forwarding reference information received from the VCF 111. The packet data forwarding policy generated by the PCF 121 may be sent to the SMF 122.

The SMF 122 may generate a data forwarding rule such as the PDR and the FAR based on the generated packet data forwarding policy and send the data forwarding rule to the UPF 123.

In one embodiment, the PDR may include parameters related to packet duplication, and the FAR may include parameters related to packet duplication instruction. The UPF may identify the mirroring requirements of the SMF 122 from the parameters related to packet duplication within the PDR and/or the parameters related to the packet duplication instruction within the FAR, duplicate filtered packet data, and forward the duplicated packets to the target endpoint.

In one embodiment, the PDR may include information such as the Internet Protocol version 4 (IPv4), Internet Protocol version 6 (IPv6), and IPv4v6-based core network (CN) tunnel information on the PDU session type, network Instance, quality of service (QOS) flow identifier (QFI), IP packet filter set, application identifier, S-NSSAI, a UE identifier, a group of UEs, a random UE, and whether packet data is duplicated. For the Ethernet-based PDU session type, the PDR may include information such as the CN tunnel information, network instance, QFI, Ethernet packet filter set, S-NSSAI, a UE identifier, a group of UEs, a random UE, and whether packet data is duplicated. The FAR may include information such as forwarding operation information, forwarding target information, and whether the packet data is duplicated.

The UPF 123 may filter the packet data to be sent to the digital twin network 30 according to the PDR, duplicate the packet data identified by the filtering, and forward the duplicated packet data to the target endpoint within the digital twin network according to the FAR.

FIG. 5 illustrates a method for duplicating network traffic of the actual network and forwarding the duplicated network traffic to a digital twin network by the PCF 121, SMF 122, and UPF 123.

The VCF 111 may request the NWDAF 14 to send the AI/ML model, which is a reliability evaluation target, to a twin instance (twin instance of the NWDAF) within the digital twin network S1530. The twin instance to which the AI/ML model is sent may be a twin instance supposed to use the AI/ML model (twin instance of the NWDAF) or a twin instance mapped to the NWDAF 14 in the actual network.

The VCF 111 may request the NWDAF 14 to send the AI/ML model through the Nmmp_MLMoldelProvision_Request service operation. Table 5 shows the information sent to the MTLF 12 through the Nmmp_MLMoldelProvision_Request service operation, where the information may be sent from the VCF 111 to the NWDAF 14 through a procedure other than the Nmmp_MLMoldelProvision_Request service operation.

The twin instance mapped to the NWDAF 14 of the actual network may perform inference by deploying the sent AI/ML model S1535 and providing the signal generated from the digital twin network 30 and forwarded duplicated traffic to the AI/ML model S1540.

When simulation starts using the digital twin network 30 in which the AI/ML model is deployed, the VCF 111 may request the MEF 113 to perform reliability evaluation of the AI/ML model S1545. At this time, the VCF 111 may send, to the MEF 113, evaluation-related information such as the AI/ML model ID, ID and information of the NF within the twin network in which the AI/ML model is deployed, the performance evaluation metric and the operational stability evaluation metric for reliability evaluation, evaluation period, evaluation duration, and a target endpoint to which to notify of the evaluation result.

In one embodiment, the VCF 111 may request the MEF 113 to perform reliability evaluation of the AI/ML model using Nmef_MLMoldelEvaluation_Subscribe service operation.

Table 4 shows the information sent to the MEF 113 through the Nmef_MLMoldelEvaluation_Subscribe service operation. The information of Table 4 may be sent from the VCF 111 to the MEF 113 through a procedure other than the Nmef_MLMoldelEvaluation_Subscribe service operation.

The MEF 113 may start evaluation of the AI/ML model by receiving necessary information and using the performance evaluation metric and the operational stability evaluation metric received from the VCF 111 S1550. The MEF 113 may collect necessary information from twin instances within the digital twin network 30 through the OAM 21 and/or from the actual network to measure the performance evaluation metric and the operational stability evaluation metric.

Once the information is collected, the MEF 113 may perform analysis of the performance evaluation metric and the operational stability evaluation metric and output the evaluation result based on the collected information S1555. When an internal policy is given in advance for the evaluation period and duration, or the entity requesting evaluation specifies the evaluation period and duration, the MEF 113 may perform evaluations periodically throughout the predetermined evaluation duration.

When the reliability evaluation result is generated, the MEF 113 may send the evaluation result to the VCF 111 S1560. The VCF 111 may send the sent reliability evaluation result to the NWDAF 14 S1565. The NWDAF 14 may determine whether to use the AI/ML model based on the reliability evaluation result. In one embodiment, the NWDAF 14 may use the AI/ML model which has satisfied the reliability evaluation criterion in the actual network.

As described above, the apparatus for verifying the reliability of an AI/ML model according to one embodiment may verify the AI/ML model by forwarding actual traffic to a twin network that replicates an environment in which the AI/ML model is actually applied. In other words, the AI/ML model's inference and optimal control may be verified through simulation of a twin network using actual traffic.

Also, as the reliability verification apparatus according to one embodiment improves the reliability of an AI/ML model, components of a core network may directly use the results at the level of control command generated by the AI/ML model, and the apparatus may be used as a key technique to the wide spread of the future 6G network fully integrated with AI.

Also, the apparatus for verifying the reliability of an AI/ML model according to one embodiment not only evaluates the reliability of an AI/ML model but also allows various resource-intensive tasks, such as network analysis, monitoring, security analysis, and data collection, to be performed in a twin network that replicates the actual operating network.

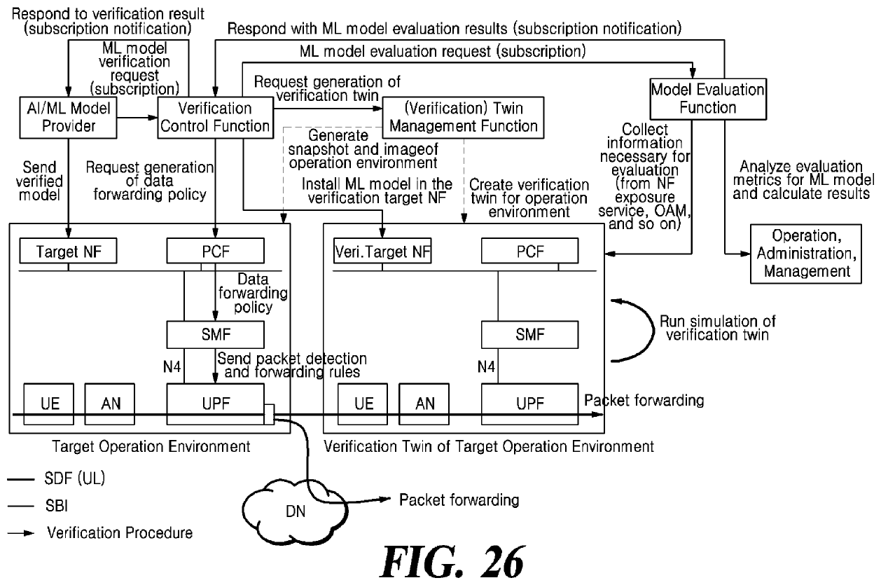

FIG. 26 is a flow diagram illustrating a method for verifying the reliability of an AI/ML model according to yet still even another embodiment.

Referring to FIG. 26, the AI/ML model provider may request a verification control function (VCF) to verify the reliability of the AI/ML model S2005. The AI/ML model provider may subscribe to the verification of the AI/ML model through a service operation (e.g., Nvcf_MLModelVerification_Subscribe service operation) provided by the VCF to request verification of the AI/ML model.

In one embodiment, the VCF may request the digital twin management function (DTMF) to generate a verification twin for verifying the AI/ML model S2010. To request generation of a digital twin for verifying a target network, the VCF may use a service operation (e.g., Ndtmf_TwinManagement_Create service operation) provided by the DTMF.

In one embodiment, the DTMF may generate a snapshot and an image of the operation environment of a target network (actual network) to generate a verification twin for verifying the AI/ML model S2015. The DTMF may generate a verification twin based on the snapshot and the image of the operation environment of the target network S2020.

In one embodiment, the VCF may install an AI/ML model in the target NF within the verification twin S2025.

Also, the VCF may request data forwarding to the verification twin from the PCF of the target network S2030. To request data forwarding, the VCF may request the PCF of the target network to generate a data forwarding policy. The PCF may generate a data forwarding policy for data forwarding to the verification twin and send the generated policy to the SMF S2035, and the SMF may generate a packet detection rule and a forwarding action rule based on the data forwarding policy and send the generated rules to the UPF S2040. The UPF may duplicate the packet according to the packet detection and forwarding action rules and forward the duplicated packet to the verification twin S2045.

Afterward, simulation may be carried out using the traffic forwarded from the actual network in the verification twin in which the AI/ML model has been deployed S2050.

In one embodiment, the VCF may request the model evaluation function (MEF) to evaluate the AI/ML model within the verification twin S2055. The VCF may request the MEF to evaluate the AI/ML model by subscribing to the service operation (Nmef_MLModelEvaluation_Subscribe) for evaluating the AI/ML model.

The MEF may collect information necessary for evaluating the AI/ML model from the NF exposure service, OAM, and so on S2060. The MEF may analyze the evaluation metric for the AI/ML model based on the information collected through the OAM and others and calculate the analysis result S2065. The MEF may inform the VCF of the evaluation result of the AI/ML model S2070. When the VCF subscribes to a service operation for the evaluation of an AI/ML model, the MEF may send the evaluation result of the AI/ML model to the VCF through a notification (e.g., Nmef_MLModelEvaluation_Notify) of the corresponding service operation.

Upon receiving the evaluation result of the AI/ML model from the MEF, the VCF may send the verification result of the AI/ML model to the AI/ML model provider S2075. When the AI/ML model provider subscribes to a service operation for the verification of an AI/ML model, the VCF may send the verification result of the AI/ML model through a notification (e.g., Nvcf_MLModelVerification_Notify) of the corresponding service operation.

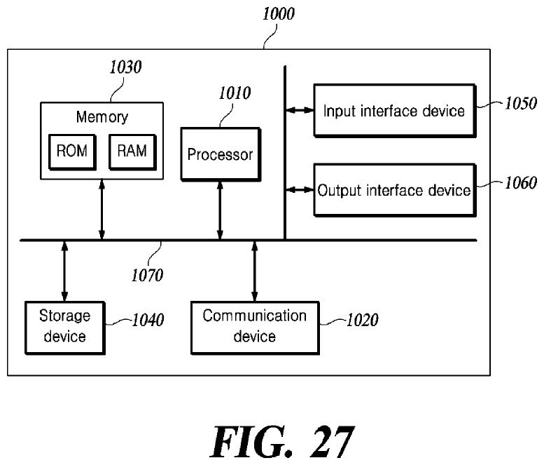

FIG. 27 illustrates an apparatus for verifying the reliability of an AI/ML model according to one embodiment.

A reliability verification apparatus according to one embodiment may be implemented in a computer system, for example, a computer-readable recording medium. Referring to FIG. 27, a computer system 1000 may include at least one of a processor 1010 communicating through a bus 1070, a memory 1030, an input interface device 1050, an output interface device 1060, and a storage device 1040. The computer system 1000 may also include a communication device 1020 connected to a network. The processor 1010 may be a central processing unit (CPU) or a semiconductor device that executes instructions stored in the memory 1030 or the storage device 1040. The memory 1030 and the storage device 1040 may include various types of volatile or non-volatile storage media. For example, memory may include a read only memory (ROM) and a random-access memory (RAM). In the embodiment of the present disclosure, the memory may be located inside or outside the processor, and the memory may be connected to the processor through various known means. The memory is a volatile or non-volatile storage medium in various forms and may include, for example, a read-only memory (ROM) or a random-access memory (RAM).

Therefore, embodiments of the present disclosure may be implemented by a method implemented in a computer or by a non-transitory computer-readable recording medium storing computer-executable instructions. In one embodiment, when executed by the processor, the computer-readable instructions may perform a method according to at least one aspect of the present disclosure.

The communication device 1020 may transmit or receive a wired signal or a wireless signal.

Meanwhile, it does not necessarily imply that the embodiments of the present disclosure may be implemented only through the apparatus and/or the method described so far. The embodiments may also be implemented by a program that embodies the functions corresponding to the configurations of the embodiments of the present disclosure or by a recording medium recording the program, wherein the implementation may be easily done by those skilled in the art to which the present disclosure belongs from the description of the embodiments above. Specifically, methods (e.g., a network management method, a data transmission method, and a transmission schedule generation method) according to the embodiments of the present disclosure may be implemented in the form of program commands which may be executed through various types of computer means and recorded in a computer-readable recording medium. The computer-readable recording medium may include program commands, data files, and data structures separately or in combination thereof. The program commands recorded in the computer-readable recording medium may be those designed and configured specifically for the present disclosure or may be those commonly available for those skilled in the field of computer software. The computer-readable recording medium may include a hardware device configured to store and perform the program commands. Examples of the computer-readable recoding medium may include magnetic media such as hard-disks, floppy disks, and magnetic tapes; optical media such as CD-ROMs and DVDs; magneto-optical media such as floptical disks, ROM, RAM, and flash memory. Program commands include not only machine codes such as those generated by a compiler but also high-level language codes which may be executed by a computer through an interpreter and the like.

Accordingly, one of ordinary skill would understand that the scope of the claimed invention is not to be limited by the above explicitly described embodiments but by the claims and equivalents thereof.

What is claimed is:

1. A method for verifying reliability of an artificial intelligence (AI) model, the method comprising:
receiving an AI model request;
creating a verification twin for evaluating the reliability of the AI model; and
verifying the reliability of the AI model based on information collected while the AI model is executed on the digital twin network.

2. The method of claim 1, wherein the receiving of the AI model request includes receiving network configuration reference information, and
the creating of a digital twin network for evaluating the reliability of the AI model creates the digital twin network based on the network configuration reference information.

3. The method of claim 2, wherein the network configuration reference information includes at least one of an identifier of an actual network, network function (NF) instance information of the actual network, context information of the actual network, an address at which information on the actual network is obtained, location information by which information on the actual network is obtained, and filter information of an instance constituting the digital twin network.

4. The method of claim 1, wherein the receiving of the AI model request includes receiving a performance evaluation metric and an operational stability evaluation metric of the AI model, and
the verifying of the reliability of the AI model evaluates the reliability of the AI model using the performance evaluation metric and the operational stability evaluation metric.

5. The method of claim 1, wherein the receiving of the AI model request includes receiving an evaluation duration and/or an evaluation period of the AI model, and
the verifying of the reliability of the AI model evaluates the reliability of the AI model over the evaluation duration or for each evaluation period.

6. The method of claim 1, further comprising:
when the digital twin network is created, instructing a user plane function (UPF) to forward traffic of an actual network to the digital twin network.

7. The method of claim 6, wherein the instructing the UPF to forward traffic of the actual network to the digital twin network includes:
generating a packet data forwarding policy based on traffic forwarding reference information, and
sending the packet data forwarding policy to the UPF.

8. The method of claim 6, wherein the instructing the UPF to forward traffic of the actual network to the digital twin network includes:
generating a data forwarding rule based on a packet data forwarding policy and
sending the data forwarding rule to the UPF.

9. The method of claim 8, wherein the data forwarding rule includes at least one of a packet detection rule (PDR) and a forwarding action rule (FAR).

10. The method of claim 1, further comprising:
receiving the AI model or receiving a storage location of the AI model.

11. The method of claim 1, further comprising:
sending the AI model and a verification result of the reliability of the AI model to a device which has request the AI model.

12. A method for forwarding traffic to a digital twin network for verifying reliability of an artificial intelligence (AI) model, the method comprising:
receiving a request for forwarding traffic of an actual network to the digital twin network;
duplicating the traffic of the actual network; and
forwarding the duplicated traffic to the digital twin network.

13. The method of claim 12, wherein the receiving of the request for forwarding traffic of the actual network to the digital twin network includes receiving traffic forwarding reference information.

14. The method of claim 13, further comprising:
generating a packet data forwarding policy based on the traffic forwarding reference information by a policy control function (PCF) in the actual network.

15. The method of claim 14, further comprising:
generating a data forwarding rule based on the packet data forwarding policy by a session management function (SMF) in the actual network, and
sending the data forwarding rule to a user plane function (UPF) in the actual network.

16. The method of claim 15, further comprising:
duplicating the traffic in the actual network based on the data forwarding rule and sending the duplicated traffic to the digital twin network by the UPF.

17. The method of claim 15, further comprising:
filtering a packet in the actual network using a packet detection rule (PDR), duplicates the filtered packet, and sending the duplicated packet to the digital twin network using a Forwarding Action Rule (FAR) by the UPF,
wherein the data forwarding rule includes the PDR and the FAR.

18. An apparatus for verifying reliability of an artificial intelligence (AI) model, the apparatus comprising:
a processor, a memory, and a communication device, wherein the processor executes a program stored in the memory to perform:
receiving the AI model request;
creating a digital twin network for evaluating the reliability of the AI model; and
verifying the reliability of the AI model based on information collected while the AI model is executed on the digital twin network.

19. The apparatus of claim 18, wherein, when the processor performs the receiving of the AI model, the processor performs:
receiving location information of the AI model; and
downloading the AI model from storage corresponding to the location information.

20. An apparatus for verifying reliability of an artificial intelligence (AI) model, the apparatus comprising:
a processor, a memory, and a communication device, wherein the processor executes a program stored in the memory to perform:
receiving a reliability verification request of the AI model;
creating a digital twin network for evaluating the reliability of the AI model;
when the digital twin network is created, requesting a device which has sent the reliability verification request to provide the AI model; and
verifying the reliability of the AI model based on information collected while the AI model is executed on the digital twin network.
